(19) United States
(12) Patent Application Publication
(10) Pub. No.: US 2019/0066657 A1
(43) Pub. Date: Feb. 28, 2019

(54) AUDIO DATA LEARNING METHOD, AUDIO DATA INFERENCE METHOD AND RECORDING MEDIUM

(71) Applicant: NATIONAL INSTITUTE OF INFORMATION AND COMMUNICATIONS TECHNOLOGY, Tokyo (JP)

(72) Inventors: Takuma OKAMOTO, Koganei-shi (JP); Kentaro TACHIBANA, Koganei-shi (JP); Tomoki TODA, Nagakute-shi (JP); Yoshinori SHIGA, Koganei-shi (JP); Hisashi KAWAI, Koganei-shi (JP)

(21) Appl. No.: 16/117,002

(22) Filed: Aug. 30, 2018

(30) Foreign Application Priority Data
Aug. 31, 2017 (JP) 2017-166495
Aug. 27, 2018 (JP) 2018-158152

(51) Int. Cl. G10L 13/047; G10L 13/027; G10L 25/18; G06N 3/08; G06N 5/04

(52) U.S. Cl. CPC G10L 13/047; G10L 13/027; G06N 5/04; G06N 3/08; G10L 25/18

(57) ABSTRACT

Provided is an audio data processing system that performs processing at high speed and obtains high-quality audio data in audio data processing using a raw audio generative model. An audio data learning apparatus of the audio data learning processing system divides full band waveform data into subband signals and performs model-learning (optimization) using the divided subband signal by a subband learning model unit. In an audio data inference apparatus, a subband learned model unit receiving at least one of an auxiliary input and subband signals performs inference processing in parallel, and a subband synthesis unit synthesizes subband signals after processing. This allows the audio data processing system to perform audio data processing using the raw audio generative at high speed.

The present application claims priority to Japanese Patent Application No. 2017-166495 filed on Aug. 31, 2017, and Japanese Patent Application No. 2018-158152 filed on Aug. 27, 2018. The entire disclosure of Japanese Patent Application No. 2017-166495 filed on Aug. 31, 2017, and Japanese Patent Application No. 2018-158152 filed on Aug. 27, 2018 is hereby incorporated herein by reference.

### BACKGROUND OF THE INVENTION

### Field of the Invention

The present invention relates to an audio data processing technique, and more particularly to an audio data processing technique using a neural network-based raw audio generative model.

In the text-to-speech synthesis technique, a statistical speech synthesis technique that is easier to control than a technique to synthesize fragments has been mainstream: however, in the statistical speech synthesis technique, due to model errors in conversion from a context label to an acoustic model and the analysis errors of the vocoder in conversion from the acoustic model to speech waveforms, and various assumptions and approximations used in the conversion, the sound quality of the synthesized speech obtained by the statistical speech synthesis technique has room for improvement. In recent years, a speech synthesis technique (audio data processing technique) using a neural network-based raw audio generative model has been introduced and been attracting attentions as a technique to achieve a higher sound quality than the statistical speech synthesis technique (for example, see Non-Patent Document 1 and 2).

The speech synthesis technique (audio data processing technique) using such a raw audio generative model inputs and processes past waveform sample data generated by the raw audio generative model and context label data to perform neural network processing for generating the next waveform data. Thus, the speech synthesis technique (audio data processing technique) using the raw audio generative model eliminates the need for estimating the acoustic model and providing a vocoder, achieving speech synthesis processing with higher sound quality than the conventional statistical speech synthesis technique. Also, the speech synthesis technique (audio data processing technique) using the raw audio generative model employs μ-law compression and treats the waveform (audio signal waveform) as data each taking one value of, for example, 256 discrete values, instead of processing using the value of the waveform (audio signal waveform) itself. As a result, in the speech synthesis technique (audio data processing technique) using the raw audio generative model, inferring the waveform is considered to be a classification problem classifying the waveform (audio signal waveform) into one of the above discrete values. In the speech synthesis technique (audio data processing technique) using the raw audio generative model, learning with a neural network so as to give an optimum solution to the classification problem obtains a learned raw audio generative model. Then, in the speech synthesis technique (audio data processing technique) using the raw audio generative model, processing the waveform (audio signal waveform) using the obtained learned raw audio generative model achieves speech synthesis processing (audio signal processing) with higher sound quality than conventional statistical speech synthesis technique.

### PRIOR ART DOCUMENT

### Non-Patent Document 1

A. van den Oord, S. Dieleman, H. Zen, K. Simonyan, O. Vinyals, A. Graves, N. Kalchbrenner, A. Senior, and K. Kavukcuoglu, “WaveNet: A generative model for raw audio,” arXiv preprint arXiv: 1609.03499, September 2016.

### Non-Patent Document 2

S. Mehri, K. Kumar, I. Gulrajani, R. Kumar, S. Jain, J. Sotelo, A. Courville, and Y. Bengio, “SampleRNN: An unconditional end-to-end neural audio generation model,” in Proc. ICLR, April 2017.

### SUMMARY

However, in the speech synthesis technique (audio data processing technique) using the above-described raw audio generative model, the past waveform sample data generated by the raw audio generative model is necessary to predict the next waveform data, thus requiring complicated neural network computation for each sample. This makes it difficult to perform parallel processing in the speech synthesis technique (audio data processing technique) using the above-described raw audio generative model; there is a problem that speech synthesis processing requires a large amount of time. In addition, the speech synthesis technique (audio data processing technique) using the above-described raw audio generative model performs learning by using time-series waveform data (audio signal) such that the S/N ratio of the waveform data (audio signal) becomes maximum. Thus, in the speech synthesis technique (audio data processing technique) using the above-described raw audio generative model, errors of the obtained waveform data (audio signal) in the frequency domain becomes uniform for all frequencies. Thus, when the speech synthesis technique (audio data processing technique) using the above-described raw audio generative model is used, the randomness becomes large in the high frequency region, thereby causing the obtained waveform data (audio data) to deteriorate in the sound quality.

In response to the above problems, it is an object of the present invention to provide an audio data learning method, an audio data inference method, and a program that perform processing at high speed and obtain high-quality audio data in audio data processing using the raw audio generative model.

A first invention for solving the above-mentioned problem is an audio data learning method including a subband dividing step, a down-sampling processing step, and a subband learning step.

The subband dividing step obtains a subband signal by performing processing to limit frequency bands with respect to audio data.

The down-sampling processing step performs down-sampling processing on the subband signal by thinning out sample data obtained by sampling a signal value of the subband signal with a sampling frequency.

The subband learning step performs learning of a raw audio generative model using an auxiliary data and the subband data obtained by the down-sampling step.

### BRIEF DESCRIPTION OF THE DRAWINGS

FIG. 1 is a schematic configuration diagram of an audio data processing system 1000 according to a first embodiment.

FIG. 2 is a schematic configuration diagram of an audio data learning apparatus DL of the audio data processing system 1000 according to the first embodiment.

FIG. 3 is a schematic configuration diagram of a subband dividing unit 1 of the audio data learning apparatus DL according to the first embodiment.

FIG. 4 is a schematic configuration diagram of an audio data inference apparatus INF of the audio data processing system 1000 according to the first embodiment.

FIG. 5 is a schematic configuration diagram of a subband synthesis unit 5 of the audio data inference apparatus INF according to the first embodiment.

FIG. 6 is a flowchart of learning processing performed by the audio data learning apparatus DL.

FIG. 7 is a diagram for explaining processing performed by the audio data learning apparatus DL, and schematically shows frequency spectra of a signal at each processing stage.

FIG. 8 is a diagram for explaining processing performed by the audio data learning apparatus DL, and schematically shows frequency spectra of a signal at each processing stage.

FIG. 9 is a flowchart of inference processing performed by the audio data inference apparatus INF.

FIG. 10 is a diagram for explaining processing performed by the audio data inference apparatus INF, and schematically shows frequency spectra of a signal at each processing stage.

FIG. 11 is a diagram for explaining processing performed by the audio data inference apparatus INF, and schematically shows frequency spectra of a signal at each processing stage.

FIG. 12 is a diagram for explaining frequency spectra of input data x (input signal x(t)), a frequency region of interest when obtaining a subband signal, and a frequency characteristic of a filter.

FIG. 13 is a diagram for explaining processing performed by the audio data learning apparatus DL, and schematically shows frequency spectra of a signal at each processing stage (frequency region R1, k=1).

FIG. 14 is a diagram for explaining processing performed by the audio data learning apparatus DL, and schematically shows frequency spectra of a signal at each processing stage (frequency region R1, k=1).

FIG. 15 is a diagram for explaining the processing performed by the audio data inference apparatus INF, and schematically shows frequency spectra of a signal at each processing stage (frequency region R1, k=1).

FIG. 16 is a diagram for explaining processing performed by the audio data inference apparatus INF, and schematically shows frequency spectra of a signal at each processing stage (frequency region R1, k=1).

FIG. 17 is a diagram for explaining processing performed by the audio data learning apparatus DL, and schematically shows frequency spectra of a signal at each processing stage (frequency region R2, k=2).

FIG. 18 is a diagram for explaining processing performed by the audio data learning apparatus DL, and schematically shows frequency spectra of a signal at each processing stage (frequency region R2, k=2).

FIG. 19 is a diagram for explaining processing performed by the audio data inference apparatus INF, and schematically shows frequency spectra of a signal at each processing stage (frequency region R2, k=2).

FIG. 20 is a diagram for explaining processing performed by the audio data inference apparatus INF, and schematically shows frequency spectra of a signal at each processing stage (frequency region R2, k=2).

FIG. 21 is a diagram for explaining processing performed by the audio data learning apparatus DL, and schematically shows frequency spectra of a signal at each processing stage (frequency region R3, k=3).

FIG. 22 is a diagram for explaining processing performed by the audio data learning apparatus DL, and schematically shows frequency spectra of a signal at each processing stage (frequency region R3, k=3).

FIG. 23 is a diagram for explaining processing performed by the audio data inference apparatus INF, and schematically shows frequency spectra of a signal at each processing stage (frequency region R3, k=3).

FIG. 24 is a diagram for explaining processing performed by the audio data inference apparatus INF, and schematically shows frequency spectra of a signal at each processing stage (frequency region R3, k=3).

FIG. 25 is a diagram showing a signal xc_shftk(t) after frequency shift processing when k=1 to 3 (regions R1 to R3 to be processed).

FIG. 26 is a diagram showing a spectrogram of audio data outputted from the audio data inference apparatus INF.

FIG. 27 is a schematic configuration diagram of an audio data processing system 3000 according to a third embodiment.

FIG. 28 is a schematic configuration diagram of an audio data learning apparatus DLa of the audio data processing system 3000 according to the third embodiment.

FIG. 29 is a schematic configuration diagram of an audio data inference apparatus INFa of the audio data processing system 3000 according to the third embodiment.

FIG. 30 is a schematic configuration diagram of an FFTNet model 6.

FIG. 31 is a schematic configuration diagram of a first layer of the FFTNet model 6.

FIG. 32 is a schematic configuration diagram of a K+1-th (k is a natural number) layer of the FFTNet model 6.

FIG. 33 is a schematic configuration diagram of a first layer FL_1a of the FFTNet model 6 according to a second modification of the third embodiment.

FIG. 34 is a schematic configuration diagram of a K+1-th layer FL_K+1 of the FFTNet model 6 according to the second modification of the third embodiment.

FIG. 35 is a schematic configuration diagram of an audio data processing system according to a third modification of the third embodiment.

FIG. 36 is a block diagram showing a hardware configuration of a computer achieving an audio data learning apparatus and an audio data inference apparatus of the present invention.

### DESCRIPTION OF THE PREFERRED EMBODIMENTS

### First Embodiment

A first embodiment will now be described below with reference to the drawings.

1.1: Configuration of Audio Data Processing System

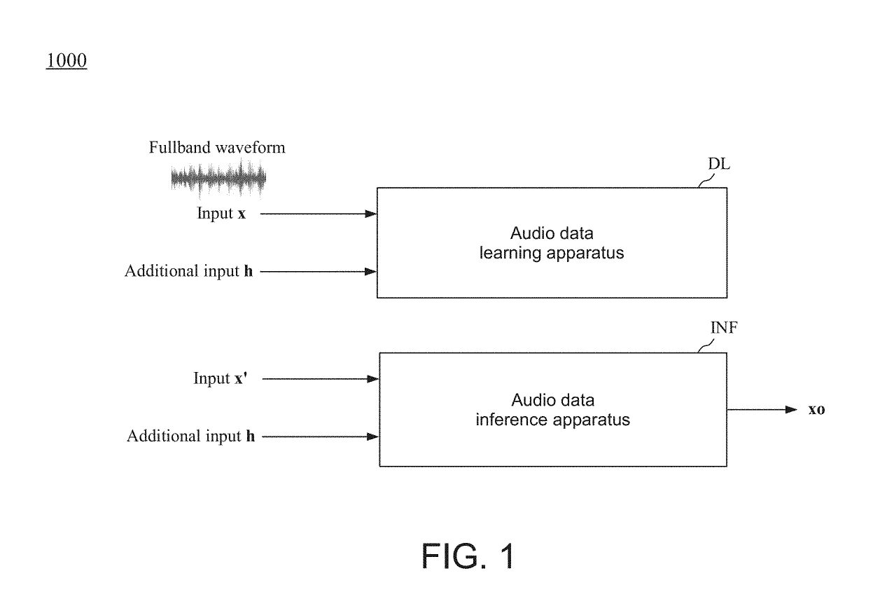

FIG. 1 is a schematic configuration diagram of an audio data processing system 1000 according to the first embodiment.

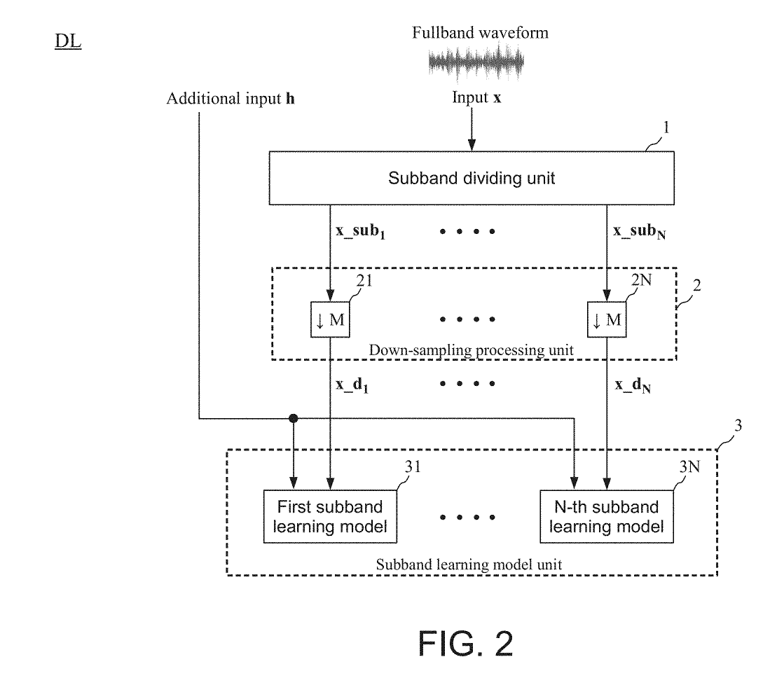

FIG. 2 is a schematic configuration diagram of an audio data learning apparatus DL of the audio data processing system 1000 according to the first embodiment.

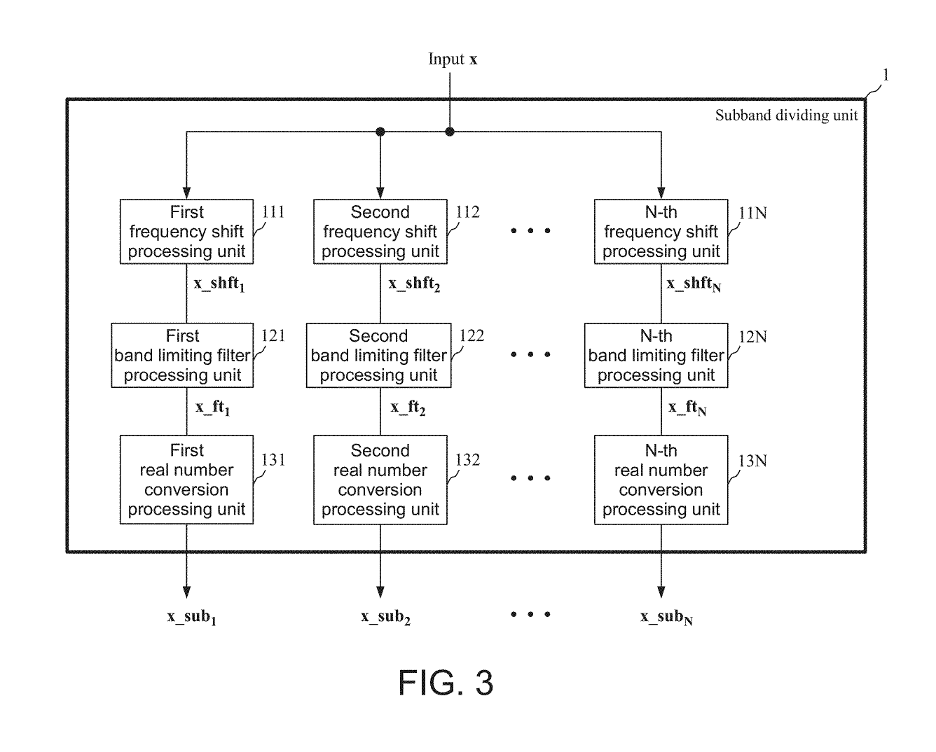

FIG. 3 is a schematic configuration diagram of a subband dividing unit 1 of the audio data learning apparatus DL according to the first embodiment.

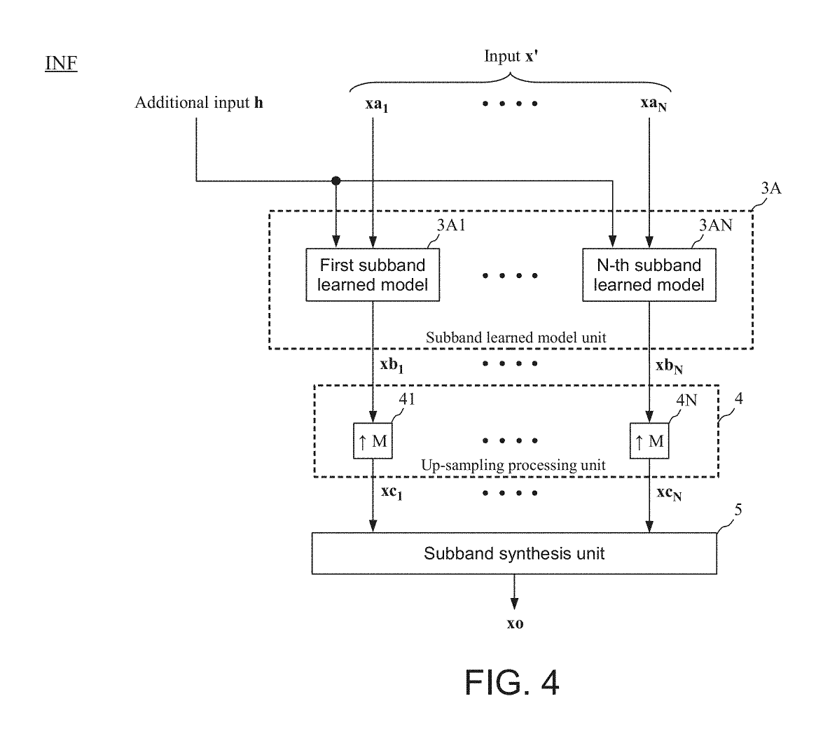

FIG. 4 is a schematic configuration diagram of an audio data inference apparatus INF of the audio data processing system 1000 according to the first embodiment.

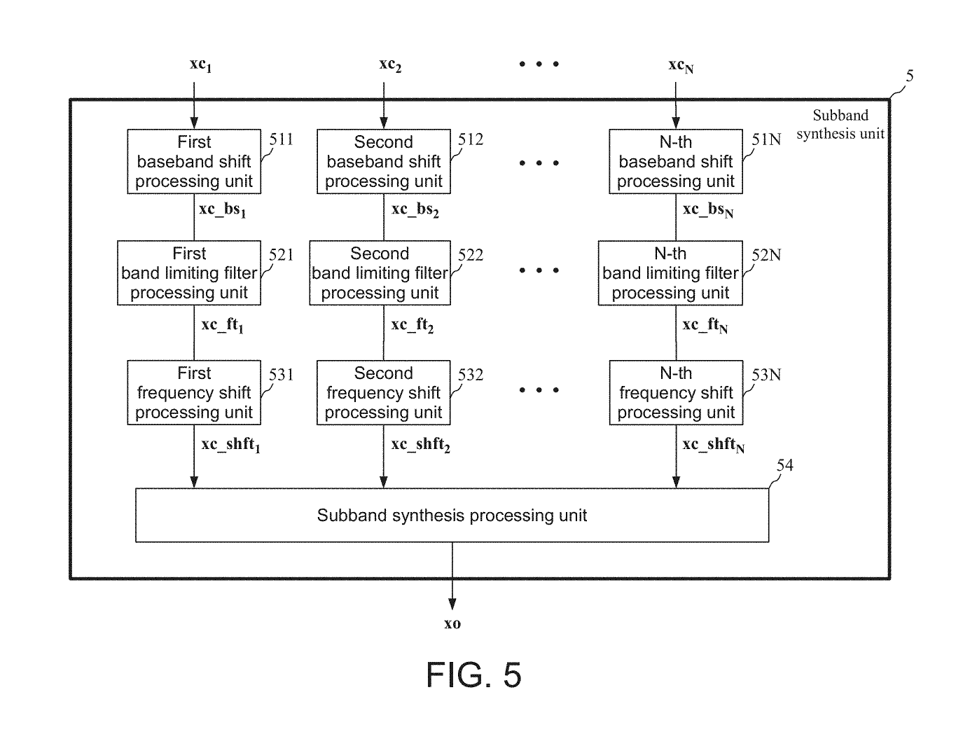

FIG. 5 is a schematic configuration diagram of a subband synthesis unit 5 of the audio data inference apparatus INF according to the first embodiment.

As shown in FIG. 1, the audio data processing system 1000 includes an audio data learning apparatus DL and an audio data inference apparatus INF.

1.1.1: Configuration of Audio Data Learning Apparatus

As shown in FIG. 2, the audio data learning apparatus DL includes a subband dividing unit 1, a down-sampling processing unit 2, and a subband learning model unit 3.

The subband dividing unit 1 receives input data x (for example, data of a waveform of a full band), performs subband dividing processing on the input data x, obtains N pieces of subband signal data x_sub₁ to x_sub_{N}, and transmits the obtained N pieces of subband signal data x_sub₁ to x_sub_{N} to N down-sampling processing units 21 to 2N, respectively.

As shown in FIG. 3, the subband dividing unit 1 includes a first frequency shift processing unit 111 to an N-th frequency shift processing unit 11N. a first band limiting filter processing unit 121 to an N-th band limiting filter processing unit 12N, and a first real number conversion processing unit 131 to an N-th real number conversion processing unit 13N.

The k-th frequency shift processing unit 11k (k is a natural number satisfying 1≤k≤N) receives input data x (for example, data of a waveform of a full band), performs frequency shift processing on the input data x, and transmits the processed data as data x_shftₖ to the k-th band limiting filter processing unit 12k.

The k-th band limiting filter processing unit 12k receives the data x_shftₖ transmitted from the k-th frequency shift processing unit 11k, performs band limit filtering processing on the received data x_shftₖ, and transmits the processed data as data x_ftₖ to the k-th real number conversion processing unit 13k.

The k-th real number conversion processing unit 13k receives the data x_ftₖ transmitted from the k-th band limiting filter processing unit 12k, performs real number conversion processing (for example, SSB (Single-sideband) modulation processing) on the received data x_ftₖ, and transmits the processed data as the data x_subₖ to the k-th down-sampling processing unit 2k of the down-sampling processing unit 2.

As shown in FIG. 2, the down-sampling processing unit 2 includes a first down-sampling processing unit 21 to an N-th down-sampling processing unit 2N (N is a natural number). The first down-sampling processing unit 21 to the N-th down-sampling processing unit 2N respectively receive the N pieces of subband signal data x_sub₁ to x_sub_{N} transmitted from the subband dividing unit 1, and perform down-sampling processing (decimating processing) with a thinning rate of M (M is a natural number) on the received subband signal data to obtain subband signal data x_d₁ to x_d_{N} after the down-sampling processing. The down-sampling processing units 21 to 2N then transmits the obtained down-sampled subband signal data x_d₁ to x_d_{N} to the subband learning model unit 3. In other words, the k-th down-sampling processing unit 2k (k is a natural number satisfying 1≤k≤N) receives the subband signal data x_subₖ transmitted from the subband dividing unit 1, and performs down-sampling processing (decimating processing) with a thinning rate of M (M is a natural number) on the received subband signal data to obtain subband signal data x_dₖ after the down-sampling processing. The k-th down-sampling processing unit 2k then transmits the obtained down-sampled subband signal data x_dₖ to the k-th subband learning model 3k.

As shown in FIG. 2, the subband learning model unit 3 includes a first subband learning model 31 to an N-th subband learning model 3N. The first subband learning model 31 to the N-th subband learning model 3N receive an auxiliary input h and the subband signal data x_d₁ to x_d_{N} after down-sampling transmitted from the first down-sampling processing unit 21 to the N-th down-sampling processing unit 2N, respectively. The first subband learning model 31 to the N-th subband learning model 3N each perform learning of the model using the received data and the auxiliary input h to optimize each model (to obtain parameters to optimize each model). Note that, in the k-th subband learning model 3k (k is a natural number satisfying 1≤k≤N), the input of the auxiliary input h is omitted and the model may be learned using only the input data (subband signal data x_dₖ).

1.1.2: Configuration of Audio Data Inference Apparatus

As shown in FIG. 4, the audio data inference apparatus INF includes a subband learned model unit 3A, an up-sampling processing unit 4, and a subband synthesis unit 5.

As shown in FIG. 4, the subband learned model unit 3A includes a first subband learned model 3A1 to an N-th subband learned model 3AN. The subband learned model units 3A1 to the N-th subband learned model 3AN are models that are learned and optimized by the first subband learning model 31 to the N-th subband learning model 3N, respectively (models that are each set with optimized parameters obtained through model learning).

As shown in FIG. 4, the k-th subband learned model 3Ak (k is a natural number satisfying 1≤k≤N) receives the auxiliary input h and the subband signal data xaₖ constituting the input data x′ in inferring, performs processing using the k-th subband learned model 3Ak on the received data, and transmits the processed data as data xbₖ to the k-th up-sampling processing unit 4k. The data transmitted to the k-th subband learned model 3Ak is data of at least one of the auxiliary input h and the subband signal data xaₖ.

As shown in FIG. 4, the up-sampling processing unit 4 includes a first up-sampling processing unit 41 to an N-th up-sampling processing unit 4N (N is a natural number), which receive data xb₁ to xb_{N} transmitted from the first sub-band learned model 3A1 to the N-th sub-band learned model 3AN, respectively. The first up-sampling processing unit 41 to the N-th up-sampling processing unit 4N (N is a natural number) perform up-sampling processing by oversampling the received data with the thinning rate of M, respectively, and transmit the processed data as data xc₁ to xc_{N} to the subband synthesis unit 5.

The subband synthesis unit 5 receives the data xc₁ to xc_{N} respectively transmitted from the first up-sampling processing unit 41 to the N-th up-sampling processing unit 4N (N is a natural number), and performs synthesis processing (addition processing) on the received data xc₁ to xc_{N} to obtain output data xo.

As shown in FIG. 5, the subband synthesis unit 5 includes a first baseband shift processing unit 511 to an N-th baseband shift processing unit 51N, a first band limiting filter processing unit 521 to an N-th band limiting filter processing unit 52N, a first frequency shift processing unit 531 to an N-th frequency shift processing unit 53N, and a subband synthesis processing unit 54.

The k-th baseband shift processing unit 51k (k is a natural number satisfying 1≤k≤N) receives input data xcₖ, performs baseband shift processing on the input data xcₖ, and transmits the processed data as data xc_bsₖ to the k-th band limiting filter processing unit 52k.

The k-th band limiting filter processing unit 52k receives the data xc_bsₖ transmitted from the k-th baseband shift processing unit 51k, performs band limit filtering processing on the received data xc_bsₖ, and transmits the processed data as data xc_ftₖ to the k-th frequency shift processing unit 53k.

The k-th frequency shift processing unit 53k receives the data xc_ftₖ transmitted from the k-th band limiting filter processing unit 52k, performs frequency shift processing on the received data xc_ftₖ, and transmits the processed data as data xc_shftₖ to the subband synthesis processing unit 54.

The subband synthesis processing unit 54 receives the data xc_shft₁ to xc_shft_{N} transmitted from the first frequency shift processing unit 531 to the N-th frequency shift processing unit 53N and performs synthesis processing (addition processing) on the received data xc_shft₁ to xc_shft_{N} to obtain output data xo.

1.2: Operation of Audio Data Processing System

The operation of the audio data processing system 1000 configured as described above will now be described.

Hereinafter, the operation of the audio data processing system 1000 will be described separately as (1) learning processing by the audio data learning apparatus DL and (2) inference processing by the audio data inference apparatus INF.

1.2.1: Learning Processing

First, learning processing by the audio data learning apparatus DL will be described.

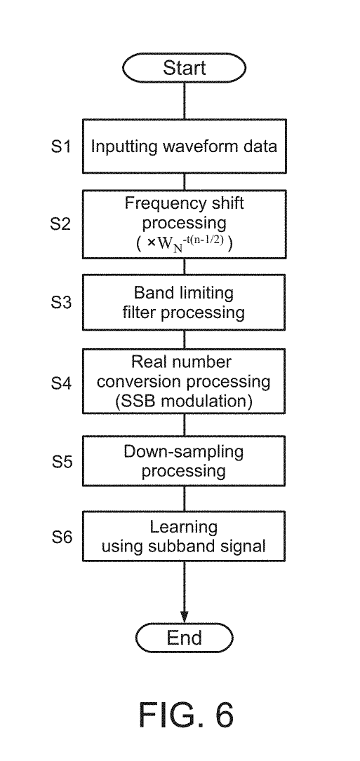

FIG. 6 is a flowchart of the learning processing performed by the audio data learning apparatus DL.

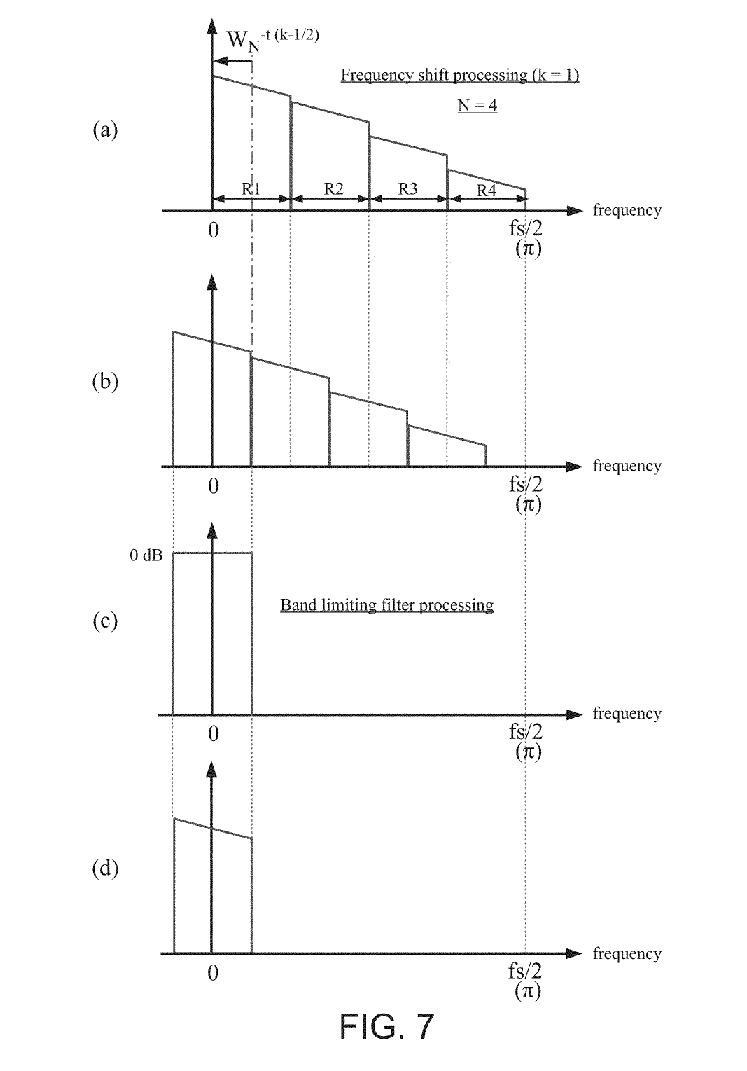

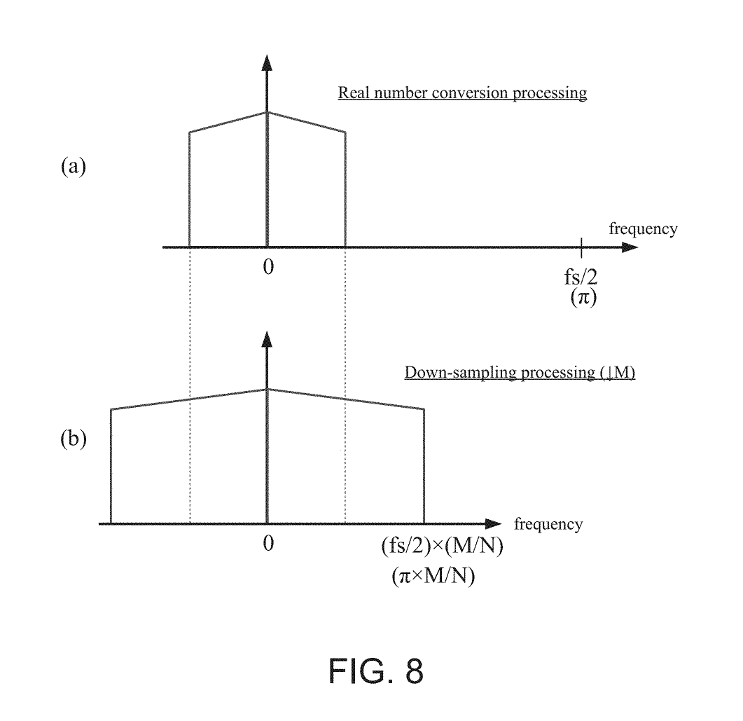

FIGS. 7 and 8 are diagrams for explaining processing performed by the audio data learning apparatus DL and are diagrams schematically showing the frequency spectra of the signal at each processing stage. In FIGS. 7 and 8, the horizontal axis represents the frequency, and the vertical axis represents the magnitude of the frequency spectra in dB.

In the following description, for ease of explanation, a case where a signal is divided into four (N=4) subband signals will be described as an example.

Hereinafter, description will be made with reference to the flowchart of FIG. 6.

### Step S1:

Input data x (for example, waveform data of a full band audio signal) is inputted into the subband dividing unit 1 of the audio data learning apparatus DL. More specifically, as shown in FIG. 3, the input data x is each transmitted to the first frequency shift processing unit 111 to the N-th frequency shift processing unit 11N of the subband dividing unit 1. In the following, the signal corresponding to the input data x is referred to as a signal x(t). In other words, the input data x (vector data x) is composed of T (T is a natural number) pieces of sample data of the signal x(t), which is expressed as follows.

x=[x(1), . . . ,x(T)]

It is assumed that x(t) is, for example, data obtained by p-law compressing an inputted audio signal such that data to be obtained takes a discrete value within a range from 0 to 255, for example.

Further, for ease of explanation, it is assumed that the number of samples is T in the following description.

It is assumed that the frequency spectra of the input signal x(t) is, for example, the one shown in FIG. 7 (a).

### Step S2:

Next, the first frequency shift processing unit 111 to the N-th frequency shift processing unit 11N performs the frequency shift processing on the received signal x(t).

More specifically, the k-th frequency shift processing unit 11k performs processing corresponding to

xₖ(t)=x(t)×W_{N}^{-t(k-1/2)}

W_{N}=exp(j×2π/(2N))

where k is a natural number satisfying 1≤k≤N, and j is the imaginary unit, thereby obtaining the signal xₖ(t) after frequency shift processing. Through the above processing, the k-th frequency shift processing unit 11k obtains data x_shftₖ after frequency shift processing as x_shftₖ=[xₖ(1), . . . , xₖ(T)]. The k-th frequency shift processing unit 11k then transmits the obtained data x_shftₖ to the k-th band limiting filter processing unit 12k.

Note that FIG. 7(b) shows frequency spectra of the signal xₖ(t) after frequency shift processing where k=1. The frequency shift processing where k=1 is performed by the first frequency shift processing unit 111. The frequency shift processing where k=2 is performed by the second frequency shift processing unit 112. The same applies to the following. The frequency shift amount to be determined by the k-th frequency shift processing unit 11k is W_{N}^{-t (k-1/2)}, and thus the frequency shift processing is performed so that the center frequency of each of the divided frequency bands (divided frequency bands indicated, in FIG. 7(a), as the frequency bands R1 to R4 (in a case where N=4)) becomes f=0.

### Step S3:

Next, the first band limiting filter processing unit 121 to the N-th band limiting filter processing unit 12N each perform band limiting filter processing on the received data x_shftₖ (the signal xₖ(t)).

More specifically, the k-th band limiting filter processing unit 12k performs band limiting with a band limiting filter having a cutoff frequency of π/(2N). Let h(t) be the impulse response of the band-limiting filter. In other words, the k-th band limiting filter processing unit 12k performs processing corresponding to

x_{k,pp}(t)=h(t)*xₖ(t),

thereby obtaining the signal x_{k, pp}(t) after band limiting processing. Note that “*” is an operator that takes a convolution sum.

Through the above processing, the k-th band limiting filter processing unit 12k obtains data x_ftₖ after band limiting processing as x_ftₖ=[x_{k, pp}(1), . . . , x_{k, pp}(T)]. The k-th band limiting filter processing unit 12k then transmits the obtained data x_ftₖ to the k-th real number conversion processing unit 13k.

FIG. 7(c) shows the frequency characteristics (an example) of the band limiting filter. The band limiting filter has a gain of 0 dB in a range satisfying −π/(2N)≤f≤π/(2N), and a gain of approximate 0 (for example, −60 dB or less) in other frequency bands. It is assumed that the frequency f is normalized frequency and satisfies f=2π when it is the same as the sampling frequency fs.

FIG. 7(d) is frequency spectra of the signal x_{k, pp}(t) after performing the band limiting filter processing with the band limiting filter having the frequency characteristics shown in FIG. 7(c).

### Step S4:

Next. the first real number conversion processing unit 131 to the N-th real number conversion processing unit 13N each performs real number conversion processing on the received data x_ftₖ (signal x_{k, pp}(t)).

More specifically, the k-th real number conversion processing unit 13k performs SSB-modulation processing. In other words, the k-th real number conversion processing unit 13k performs processing corresponding to

x_{k,SSB}(t)=x_{k,pp}(t)×W_{N}^{t/2}+x*_{k,pp}(t)×W_{N}^{-t/2},

thereby obtaining a signal x_{k, SSB}(t) after real number conversion processing. Note that “x*_{k, pp}(t)” is a complex conjugate signal of “x_{k, pp}(t)”.

Through the above processing, the k-th real number conversion processing unit 13k obtains data x_subₖ after real number conversion processing as x_subₖ=[x_{k, SSB}(1), . . . , x_{k, SSB}(T)]. The k-th real number conversion processing unit 13k then transmits the obtained data x_subₖ to the k-th down-sampling processing unit 2k.

FIG. 8(a) shows frequency spectra of the signals x_{k, SSB}(t) after real number conversion processing.

### Step S5:

Next, the first down-sampling processing unit 21 to the N-th down-sampling processing unit 2N each perform down-sampling processing (thinning processing) on the received data x_subₖ (signal x_{k, SSB}(t)) with a thinning rate of M (M is a natural number) to obtain data x_dₖ after down-sampling processing. In this embodiment, as an example, it is assumed that M=4.

Through the above processing, the k-th down-sampling processing unit 2k obtains data x_dₖ after down-sampling processing as x_dₖ=[x_{k, SSB}(M), . . . , x_{k, SSB}(T×M)]. The k-th down-sampling processing unit 2k then transmits the obtained data x_dₖ to the k-th subband learning model 3k.

FIG. 8(b) shows frequency spectra of the signal x_{k, SSB}(t×M) after down-sampling processing.

### Step S6:

Next, in the first to N-th subband learning models 31 to 3N of the subband learning model unit 3, model learning is performed using the auxiliary input h and the subband signal data x_d₁ to x_d_{N} after down-sampling processing transmitted from the first down-sampling processing unit 21 to the N-th down-sampling processing unit 2N, respectively. Note that the input of the auxiliary input h may be omitted.

In the prior art, given an auxiliary input h such as a context label, the conditional probability distribution of a waveform x=[x(1), . . . , X(T)] of an audio signal is modeled, by stacking the expanded convolutional layers, as follows.

$$p ( x \vert h ) = {\prod }_{t = 1}^{T} p ( x ( t ) \vert x ( 1 ) , ⋯ , x ( t - 1 ) , h ) \qquad Formula 1$$

Parameters of the model are then optimized so that the conditional probability is maximized. In other words, in the above model, optimization processing of the model (model learning) can be performed by obtaining the optimization parameter θₒₚₜ using the following formula.

$${θ}_{opt} = {argmax}_{θ} p ( x \vert h ; θ ) \qquad Formula 2$$

However, in the above model, in order to obtain the conditional probability p(x|h), all past sample data, that is, x(1) to x(t−1) is required: thus, the larger the number T of samples is, the larger the calculation amount becomes.

For addressing this issue, the audio data learning apparatus DL uses subband signals, which are obtained by performing the above processing for dividing the inputted full band waveform signal into subband signals, thereby allowing for easily performing processing in parallel and achieving high-speed processing.

More specifically, using the auxiliary input h such as the context label and the data x_dₖ obtained by the k-th down-sampling processing unit 2k, the k-th subband learning model 3k performs model learning with a model in which the conditional probability p(x_dₖ|h) is defined as follows.

$$p ( {x}_{—} {d}_{k} \vert h ) = {\prod }_{t = 1}^{T \text{/} M} p ( {x}_{—} {d}_{k} ( t ) \vert {x}_{—} {d}_{k} ( 1 ) , ⋯ , {x}_{—} {d}_{k} ( t - 1 ) , h ) \qquad Formula 3$$

Note that when t=1, p(x_dₖ(t)|x_dₖ(1), . . . , x_dₖ(t−1), h) can be set to p(x_dₖ(1)|h).

Also, x_dₖ(1)=x_{k, SSB}(M) and x_dₖ(t)=x_{k, SSB}(t F M) are satisfied. In other words, the k-th subband learning model 3k needs only one M-th (i.e., 1/M times) as much as an amount of target data for obtaining the conditional probability p(x_dₖ|h) needed in using the full band waveform data, which is, for example, used in the conventional technique.

The k-th subband learning model 3k then optimizes the parameters of the model so that the conditional probability is maximized. In other words, the k-th subband learning model 3k performs model-optimization processing (model learning) by obtaining the optimized parameter θₒₚₜ_{_}ₖ through processing corresponding to the following formula.

$${θ}_{{opt}_{—} k} = {arg max}_{{θ}_{k}} p ( {x}_{—} {d}_{k} \vert h ; {θ}_{k} ) \qquad Formula 4$$

Note that the parameter θₖ is a scalar, a vector, or a tensor.

As described above, the first to N-th subband learning models 31 to 3N of the subband learning model unit 3 each perform learning processing.

1.2.2 Inference Processing

Next, inference processing with the audio data inference apparatus INF will be described.

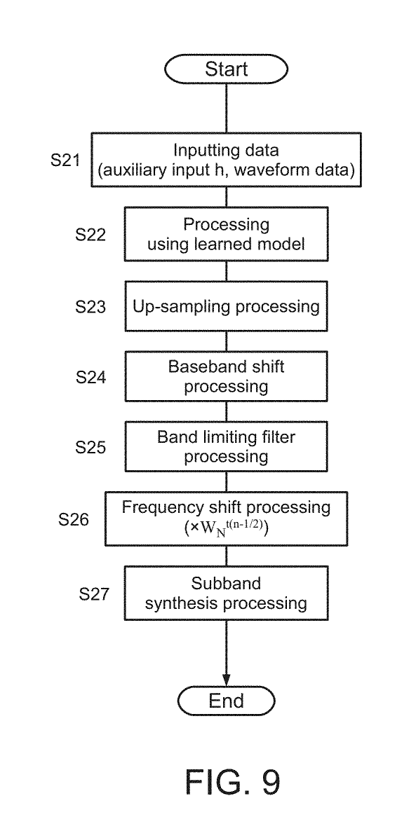

FIG. 9 is a flowchart of inference processing performed by the audio data inference apparatus INF.

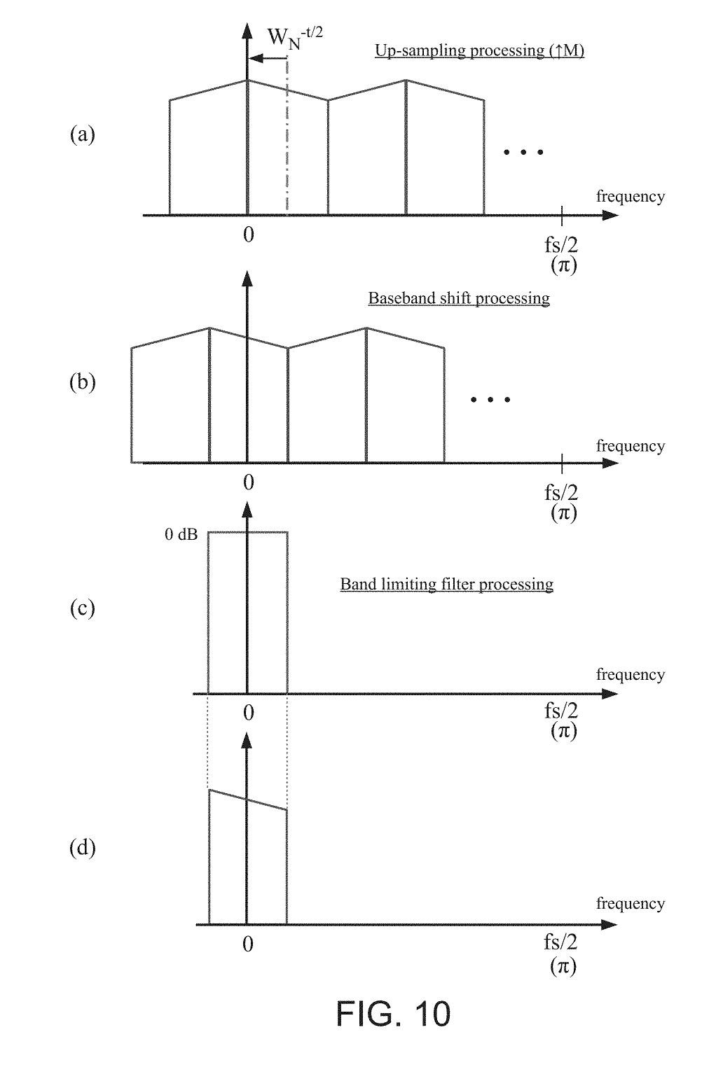

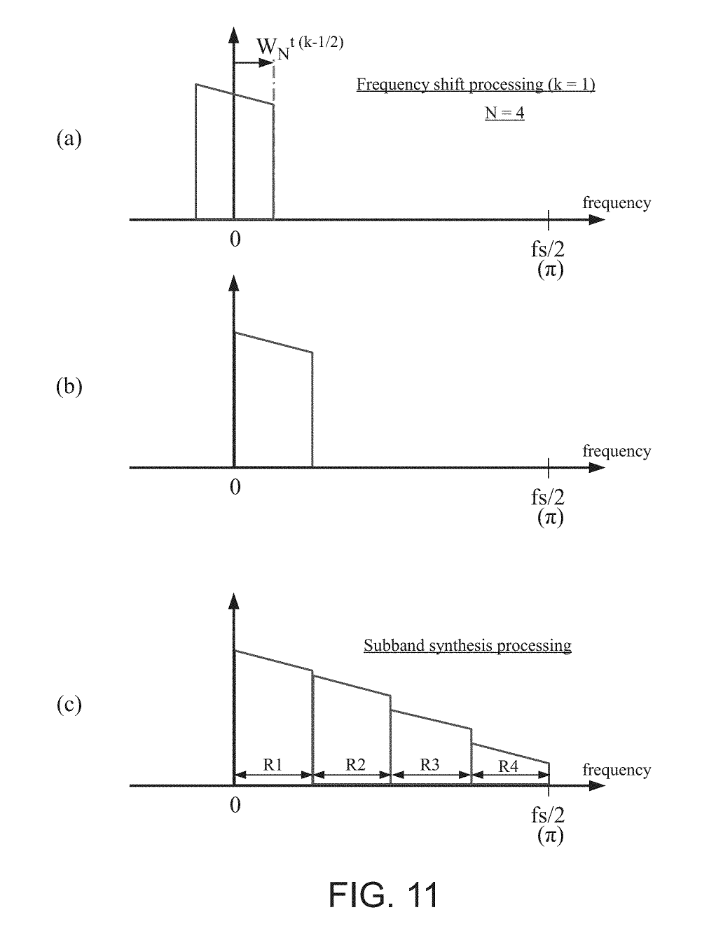

FIGS. 10 and 11 are diagrams for explaining processing performed by the audio data inference apparatus INF and schematically show frequency spectra of signals at each processing stages. In FIGS. 10 and 11, the horizontal axis represents the frequency, and the vertical axis represents the magnitude of the frequency spectra in dB.

In the following description, for ease of explanation, a case where a signal is divided into four (N=4) subband signals will be described as an example.

Hereinafter, description will be made with reference to the flowchart of FIG. 9.

### Step S21:

The auxiliary input h and the subband signal data xaₖ constituting the input data x′ in inferring are inputted into the subband learned model unit 3A of the audio data inference apparatus INF.

Note that the subband signal data xaₖ is the same signal as a signal obtained by performing the same processing as above on the input data x′ (signal x′(t)) in the subband dividing unit 1 and the down-sampling processing unit 2. Thus, a signal (a signal transmitted from the down-sampling processing unit 2) obtained by performing the same processing as above on the data x′ (signal x′(t)), which is inputted into the subband dividing unit 1, in the subband dividing unit 1 and the down-sampling processing unit 2 may be inputted into the subband learned model unit 3A as the subband signal data xaₖ.

Note that the data inputted into the k-th subband learned model 3Ak is data of at least one of the auxiliary input h and the subband signal data xaₖ.

### Step S22:

The subband learned model unit 3A performs processing on the auxiliary input h and the subband signal data xaₖ using the k-th subband learned model 3Ak, thereby obtaining data after the processing as data xbₖ.

More specifically, it is assumed that xaₖ(t) takes a discrete value within a range from 0 to 255, and a value at which the conditional probability p(xaₖ|h) obtained by the following formula is maximum is determined to be set as a value of xaₖ(t).

$$p ( {xa}_{k} \vert h ) = {\prod }_{t = 1}^{T \text{/} M} p ( {xa}_{k} ( t ) \vert {xa}_{k} ( 1 ) , ⋯ , {xa}_{k} ( t - 1 ) , h ) \qquad Formula 5$$

Note that in a case of t=1, p(xaₖ(t)|xaₖ(1), . . . , xaₖ(t−1), h) can be set to p(xaₖ(1)|h).

For example, assuming that the conditional probability p(xaₖ|h) obtained by the k-th subband learned model 3Ak has the maximum value when xaₖ(t)=200, xaₖ(t) is determined to be set as xaₖ(t)=200.

Through such processing, the k-th subband learned model 3Ak (k is a natural number satisfying 1≤k≤N) obtains data xbₖ (signal xbₖ(t)) transmitted from the k-th subband learned model 3Ak.

Note that the processing (inference processing) using the k-th subband learned model 3Ak is processing using a subband signal obtained by performing down-sampling processing on the full band waveform data with a thinning rate of M. Thus, an amount of target data for obtaining the conditional probability p(xaₖ|h) can be reduced to 1/M times as much as an amount of target data for obtaining the conditional probability p(x_d₁|h) needed in using the full band waveform data, which is, for example, used in the conventional technique.

Thus, in the processing (inference processing) using the N subband learned models, the processing can be performed M times as fast as in a case of using the full band waveform data as in the conventional technique.

The first subband learned model 3A1 to the N-th subband learned model 3AN can perform processing in parallel as shown in FIG. 4. and thus the inference processing in the subband learned model unit is performed at a speed that is about M times faster than when full band waveform data is used as in the conventional technique.

The data xb₁ (signal xb₁(t)) to xb_{N} (signal xb_{N}(t)) obtained by the first subband learned model 3A1 to the N-th subband learned model 3AN as described above are transmitted from the subband learned model unit 3A to the up-sampling processing unit 4.

### Step S23:

Next, the first up-sampling processing unit 41 to the N-th up-sampling processing unit 4N perform up-sampling processing (e.g., perform up-sampling by zero-insertion) by performing oversampling on the input data xbₖ (signal xbₖ(t)) with a thinning rate of M, thereby obtaining data xcₖ (signal xcₖ(t)) after up-sampling processing.

FIG. 10 (a) shows frequency spectra of the signal xcₖ(t) after up-sampling processing. As shown in FIG. 10(a), the signal xcₖ(t) after up-sampling processing is in a state in which aliasing distortion is occurring, and thus the signal xcₖ(t) needs to be shifted to the baseband and band limitation needs to be performed so that aliasing distortion does not occur.

### Step S24:

Next, the first baseband shift processing unit 511 to the N-th baseband shift processing unit 51N of the subband synthesis unit 5 each perform baseband shift processing on the received data xcₖ (signal xcₖ(t)) after up-sampling processing.

More specifically, the k-th baseband shift processing unit 51k performs processing corresponding to

xc_bsₖ(t)=xcₖ(t)×W_{N}^{-1/2}

W_{N}=exp(j×2π/(2N))

where k is a natural number satisfying 1≤k≤N and j is the imaginary unit, thereby obtaining a signal xc_bsₖ(t) after baseband shift processing. The k-th baseband shift processing unit 51k then transmits the obtained data xc_bsₖ (signal xc_bsₖ(t)) to the k-th band limiting filter processing unit 52k.

FIG. 10(b) shows frequency spectra of the signal xc_bsₖ(t) after baseband shift processing.

### Step S25:

Next, the first band limiting filter processing unit 521 to the N-th band limiting filter processing unit 52N each perform band limiting filter processing on the received data xc_bsₖ (the signal xc_bsₖ(t)).

More specifically, the k-th band limiting filter processing unit 52k performs band limiting with a band limiting filter having a cutoff frequency of π/(2N). Note that let h(t) be the impulse response of the band limiting filter. In other words, the k-th band limiting filter processing unit 52k performs processing corresponding to the follow formula, thereby obtaining a signal xc_ftₖ(t) after band limiting processing.

xc_ftₖ(t)=h(t)*xc_bsₖ(t)

Note that “*” is an operator that takes a convolution sum.

The k-th band limiting filter processing unit 52k then transmits the obtained data xc_ftₖ (signal xc_ftₖ(t)) to the k-th frequency shift processing unit 53k.

Note that FIG. 10(c) shows the frequency characteristics (an example) of a band limiting filter. The band limiting filter has a gain of 0 dB in a frequency region satisfying −π(2N)≤f≤π/(2N), and has a gain of about zero (for example, −60 dB or less) in other frequency regions. It is assumed that the frequency f is a normalized frequency and f=2π is satisfied when the frequency f is equal to the sampling frequency fs.

FIG. 10(d) shows the frequency spectra of the signal xc_ftₖ(t) after performing the band limiting filter processing by the band limiting filter having the frequency characteristics of FIG. 10(c).

### Step S26:

Next, the first frequency shift processing unit 531 to the N-th frequency shift processing unit 53N each perform frequency shift processing on the received signal xc_ftₖ(t).

More specifically, the k-th frequency shift processing unit 53k performs processing corresponding to the following formula, thereby obtaining a signal xc_shftₖ(t) after frequency shift processing.

xc_shftₖ(t)=xc_ftₖ(t)×W_{N}^{t(k-1/2)}

W_{N}=exp(j×2π/(2N))

k: a natural number satisfying 1≤k≤N

j: the imaginary unit

The k-th frequency shift processing unit 53k then transmits the obtained data xc_shftₖ (signal xc_shftₖ(t)) to the subband synthesis processing unit 54.

FIG. 11(a) shows the frequency spectra of the signal xc_ftₖ(t) before frequency shift processing.

Note that FIG. 11(b) shows the frequency spectra of the signal xc_shftₖ(t) after frequency shift processing when k=1 is satisfied. The frequency shift processing when k=1 is satisfied is performed by the first frequency shift processing unit 531. The frequency shift amount in the k-th frequency shift processing unit 53k is W_{N}^{t(k-1/2)}, and thus the frequency spectra of the signal after processing in the k-th frequency shift processing unit 53k return to positions of frequency spectra of the original subband signal.

In the case of N=4, the frequency spectra of the regions R1 to R4 in FIG. 11(c) respectively corresponds to frequency spectra of the signals xc_shft₁(t) to xc_shft₄(t) obtained by the first frequency shift processing unit 531 to the fourth frequency shift processing unit 534.

### Step S27:

The subband synthesis processing unit 54 receives the data xc_shft₁ to xc_shft_{N} transmitted from the first frequency shift processing unit 531 to the N-th frequency shift processing unit 53N and performs synthesis processing (addition processing) on the received data xc_shft₁ to xc_shft_{N} to obtain output data xo (signal xo(t)).

FIG. 11(c) shows the frequency spectra of the signal xo(t) after subband synthesis processing by the subband synthesis processing unit 54. As can be seen from FIG. 11(c), the full band signal is properly restored from the subband signal by the above processing.

As described above, in the audio data learning apparatus DL of the audio data processing system 1000, the full band waveform data (full band audio signal) is divided into subband signals, and the subband learning model unit 3 performs learning (optimization) using the subband signals obtained by dividing the full band waveform. N models (the first subband learning model to the N-th subband learning model) in the subband learning model unit 3 allows for performing, in parallel, learning (optimization) of a model using subband signals. In other words, the audio data learning apparatus DL achieves learning (optimization) of the raw audio generative model using parallel processing.

In addition, in the audio data inference apparatus INF of the audio data processing system 1000, the inference processing that is performed in parallel is achieved by the subband learned model unit 3A that receives at least one of the auxiliary input h and the subband signal. In other words, using N subband learned models (first to N-th subband learned models) in the subband learned model unit 3A allows for performing inference processing on subband signals in parallel. The audio data inference apparatus INF performs up-sampling processing on the inference result data of the N subband learned models (the first to the N-th subband learned models) and then performs the band synthesis processing, thereby obtaining the processing result data of the inference processing on the full band audio data.

In other words, the audio data inference apparatus INF achieves inference processing of the raw audio generative model using parallel processing. As a result, the inference processing in the audio data inference apparatus INF is performed much faster than the inference processing with the raw audio generative model using the full band waveform data as in the conventional technique.

As described above, the audio data processing system allows audio data processing using the raw audio generative model to be performed at high speed.

### Second Embodiment

Next, a second embodiment will be described.

In the first embodiment, a case in which when N=M=4 is satisfied, that is, when the value of N (the number of subband divisions) equals the value of M (thinning rate), the subband dividing unit 1 and the subband synthesis unit 5 perform the band limiting filter processing with the ideal band limiting filter is described. In the second embodiment, a case in which when the value of N (the number of subband divisions) differs from the value of M (thinning rate), and the subband dividing unit 1 and the subband synthesis unit 5 further perform band limiting filter processing using a filter having square root cosine characteristics (a square root Hann window type filter) will be described.

In the second embodiment, detailed description of portions similar to those of the first embodiment will be omitted. Furthermore, the configurations of the audio data processing system, the audio data learning apparatus DL, and the audio data inference apparatus INF of the second embodiment are the same as those of the first embodiment.

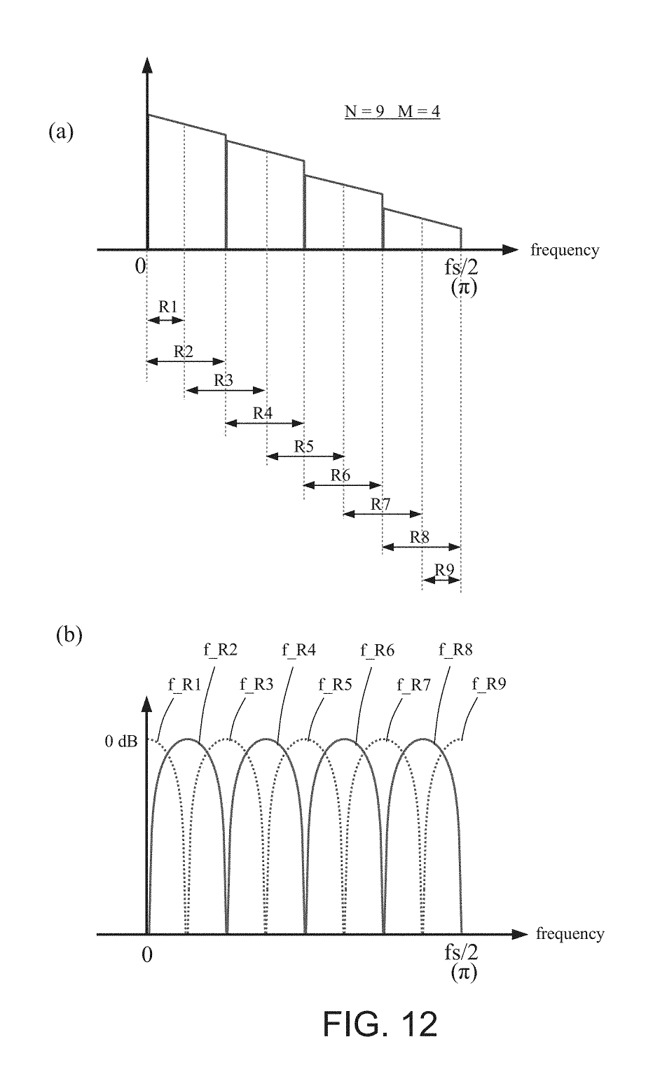

In the present embodiment, a case in which processing is performed on waveform data (audio signal) having frequency spectra shown in FIG. 12(a) in the same manner as in the first embodiment will be described.

Further, in the present embodiment, a case in which N=9 (subband division number) and M=4 (thinning rate) are satisfied will be described.

FIG. 12(a) is a diagram showing frequency spectra of the input data x (input signal x(t)) and the frequency regions of interest in obtaining the subband signal. In FIG. 12(a), frequency regions to be processed in obtaining the subband signal x_subₖ (k is a natural number satisfying 1≤k≤N) are shown as frequency regions Rk (R1 to R9). As shown in FIG. 12(a), the frequency regions Rk (R1 to R9) are set so that their center frequencies are each shifted by π/(N−1) (e.g., π/8 when N=9). The frequency regions R1 and R9 are frequency bands each having a frequency width of π/(N−1), and the other frequency regions R2 to R8 are frequency bands each having a frequency width of 2π/(N−1).

FIG. 12(b) shows frequency characteristics of a filter (the square root Hann window type filter), which are obtained by shifting frequency characteristics of a filter having the following transfer function by π/(N−1) in the direction of the frequency axis in which frequency increases.

(1) If −π/(N−1)≤ω≤π/(N−1) is satisfied, then

$$H ( ω ) = \sqrt{cos ( \frac{N - 1}{2} ω )} \qquad Formula 6$$

(2) If ω<−π/(N−1) or ω>π/(N−1) is satisfied, then

H(ω)=0

ω: angular frequency

In other words, performing, on a signal, band limiting filter processing for obtaining a subband signal and band limiting filter processing for synthesizing the subband signal in the audio data processing system in both of the learning process and the inference process equals performing, on the signal, band limiting processing having cosine characteristics that correspond to characteristics in performing filtering processing having square root cosine characteristics. As shown in FIG. 12. frequency regions to be subband divided are shifted by π/(N−1) and have each a region with a width of π/(N−1) that overlaps with an adjacent subband divided region (subband frequency region). Consequently, a signal obtained by subband-synthesizing the subband divided signals has little energy loss as compared with its original signal, thus restoring (estimating) the original signal appropriately.

In other words, the signal transmitted from the subband synthesis unit equals a signal including the following components.

(1) signal components obtained by performing filter processing having filter characteristics f_R1 on frequency components included in the frequency region of θ≤f<π/8 twice (in learning and in inferring) and signal components obtained by performing filter processing having filter characteristics f_R2 on frequency components included in the frequency region of θ≤f<π/8 twice.
(2) signal components obtained by performing filter processing having filter characteristics f_R2 on frequency components included in the frequency region of π/8≤f<2π/8 twice (in learning and in inferring) and signal components obtained by performing filter processing having filter characteristics f_R3 on frequency components included in the frequency region of π/8≤f<2π/8 twice.
(3) signal components obtained by performing filter processing having filter characteristics f_R3 on frequency components included in the frequency region of 2π/8≤f<3π/8 twice (in learning and in inferring) and signal components obtained by performing filter processing having filter characteristics f_R4 on frequency components included in the frequency region of 2π/8≤f<3π/8 twice.
(4) signal components obtained by performing filter processing having filter characteristics f_R4 on frequency components included in the frequency region of 3π/8≤f<4π/8 twice (in learning and in inferring) and signal components obtained by performing filter processing having filter characteristics f_R5 on frequency components included in the frequency region of 3π/8≤f<4π/8 twice.
(5) signal components obtained by performing filter processing having filter characteristics f_R5 on frequency components included in the frequency region of 4π/8≤f<5π/8 twice (in learning and in inferring) and signal components obtained by performing filter processing having filter characteristics f_R6 on frequency components included in the frequency region of 4π/8≤f<5π/8 twice.
(6) signal components obtained by performing filter processing having filter characteristics f_R6 on frequency components included in the frequency region of 5π/8≤f<6π/8 twice (in learning and in inferring) and signal components obtained by performing filter processing having filter characteristics f_R7 on frequency components included in the frequency region of 5π/8≤f<6π/8 twice.
(7) signal components obtained by performing filter processing having filter characteristics f_R7 on frequency components included in the frequency region of 6π/8≤f<7π/8 twice (in learning and in inferring) and signal components obtained by performing filter processing having filter characteristics f_R8 on frequency components included in the frequency region of 6π/8≤f<7π/8 twice.
(8) signal components obtained by performing filter processing having filter characteristics f_R8 on frequency components included in the frequency region of 7π/8≤f<π twice (in learning and in inferring) and signal components obtained by performing filter processing having filter characteristics f_R9 on frequency components included in the frequency region of 7π/8≤f<π twice.

Consequently, a signal obtained by subband-synthesizing subband divided signals has no deterioration as compared with its original signal, thus restoring (estimating) the original signal.

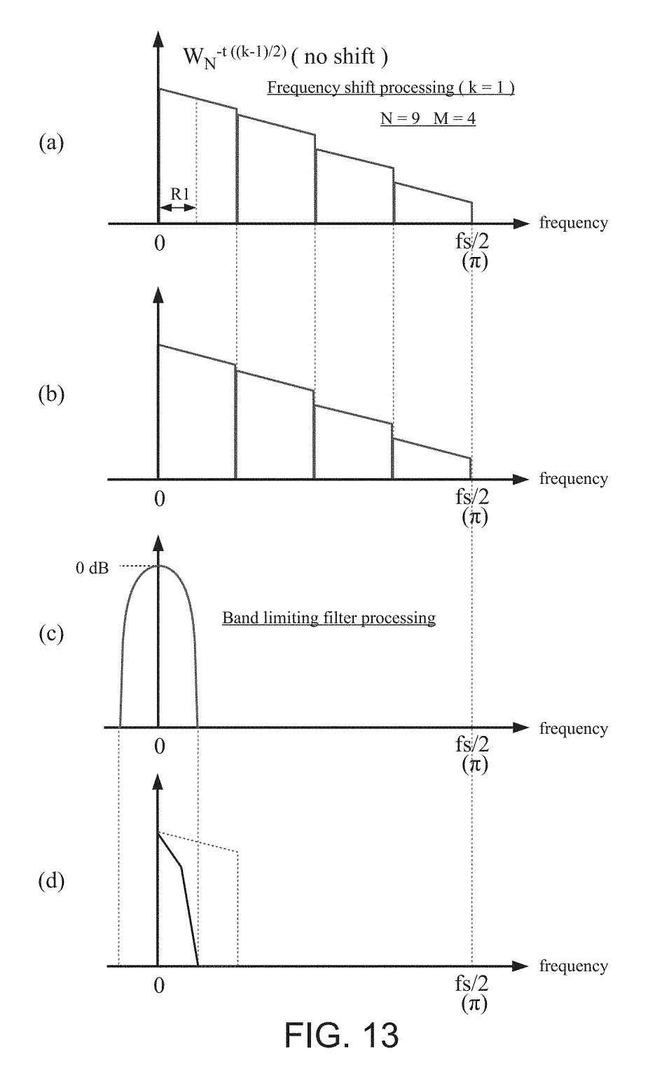

Hereinafter, the present embodiment will be described with reference to diagrams showing the frequency spectra of each signal shown in FIGS. 13 to 25.

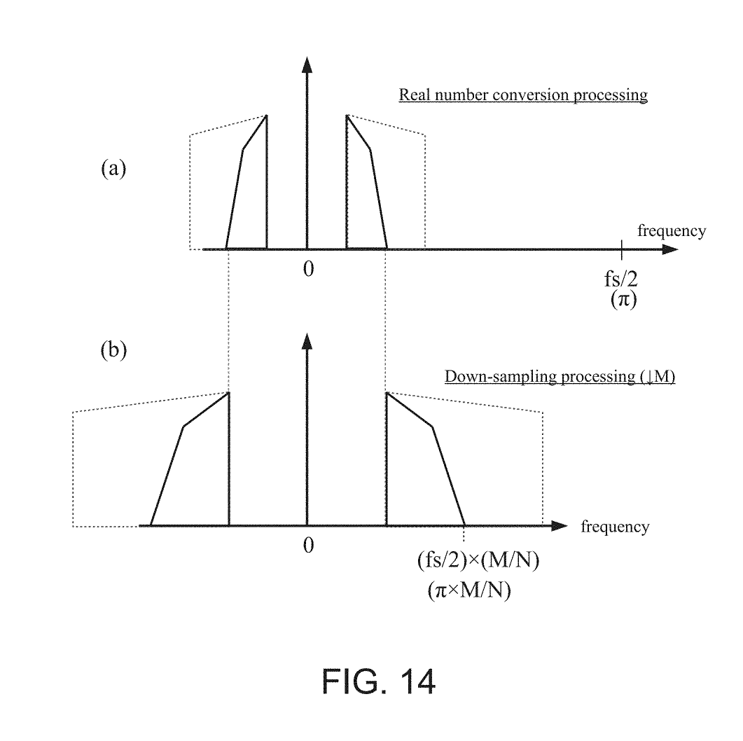

FIGS. 13 and 14 are diagrams for explaining processing performed by the audio data learning apparatus DL and schematically show frequency spectra of the signal at each processing stage (frequency region R1, k=1).

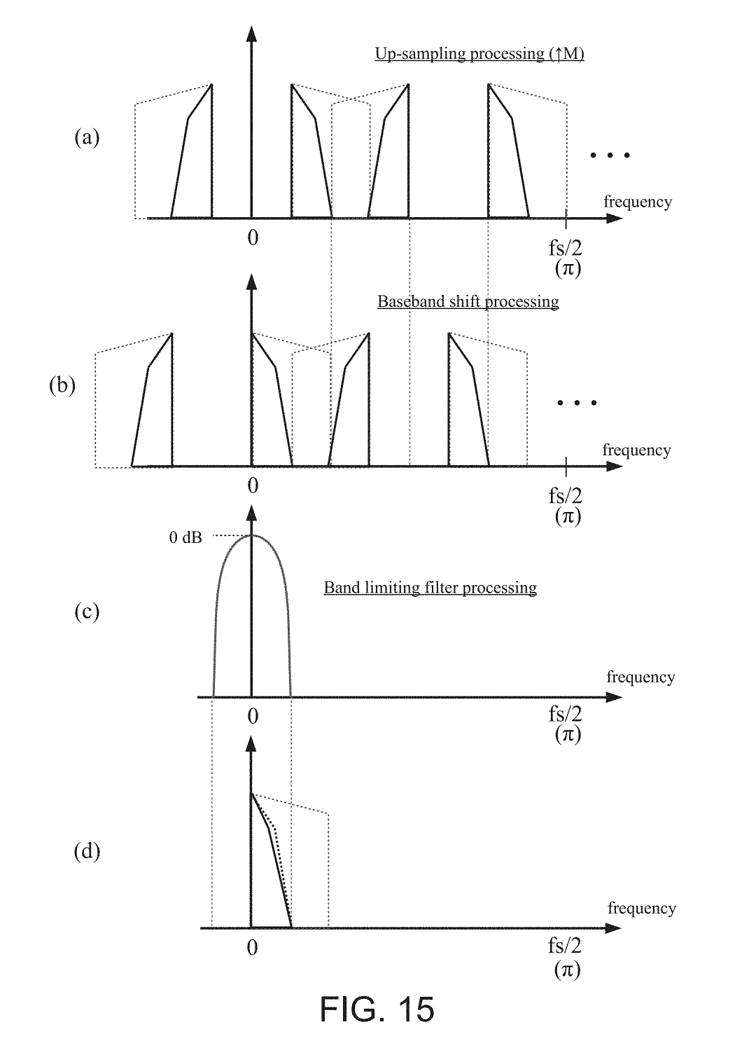

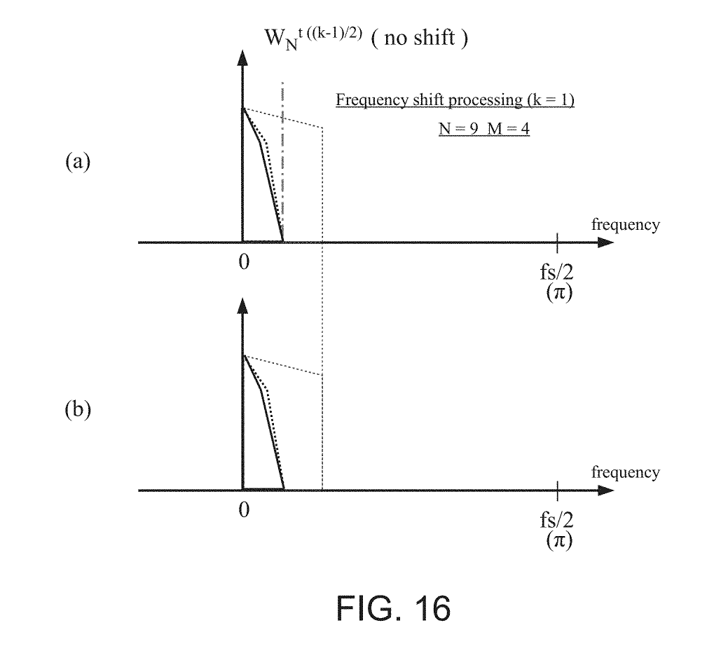

FIGS. 15 and 16 are diagrams for explaining processing performed by the audio data inference apparatus INF, and schematically show frequency spectra of the signal at each processing stage (frequency region R1, k=1).

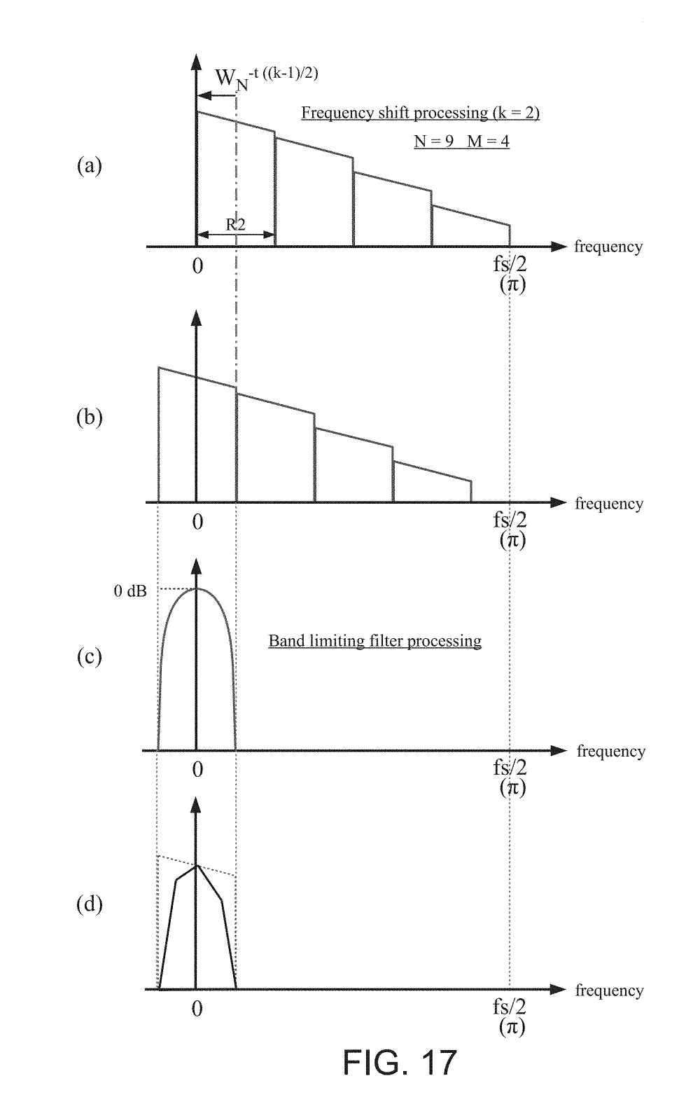

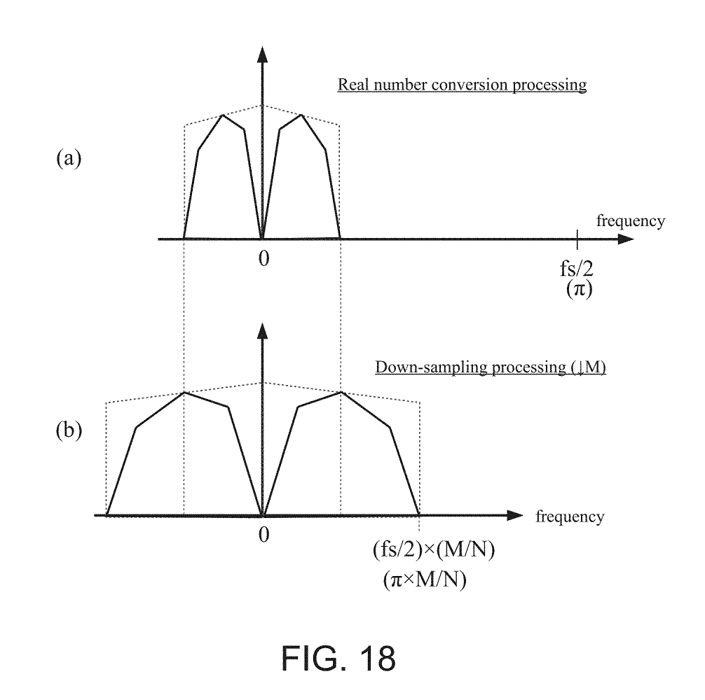

FIGS. 17 and 18 are diagrams for explaining processing performed by the audio data learning apparatus DL, and schematically show the frequency spectra of the signal at each processing stage (frequency region R2, k=2).

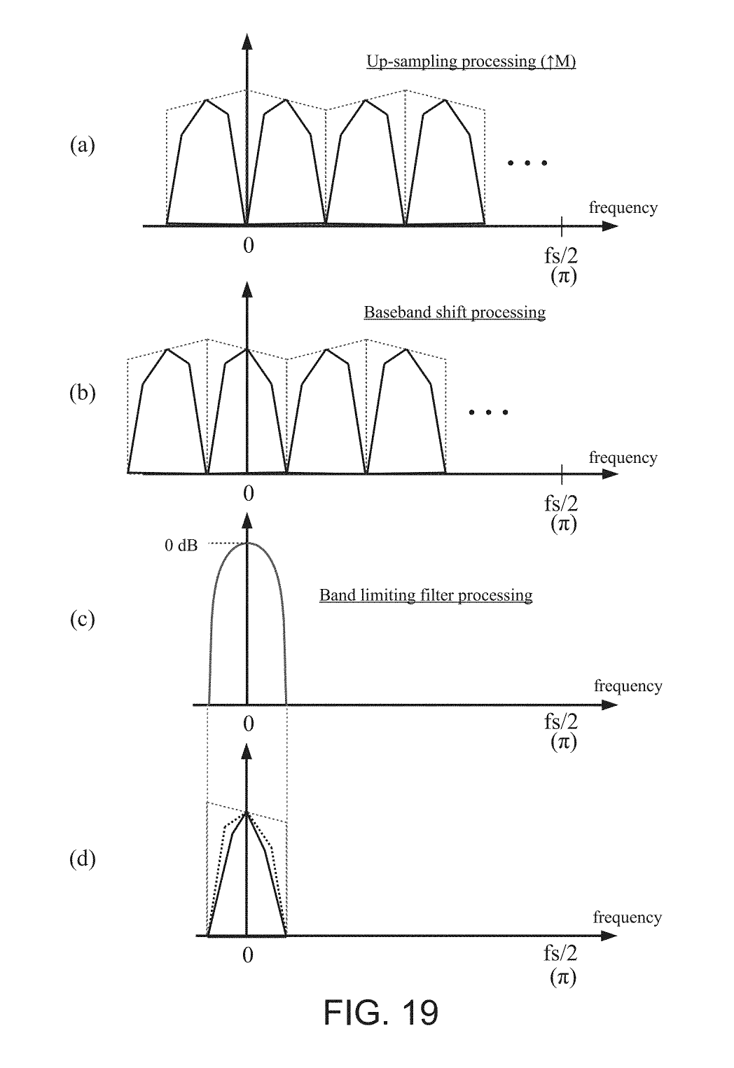

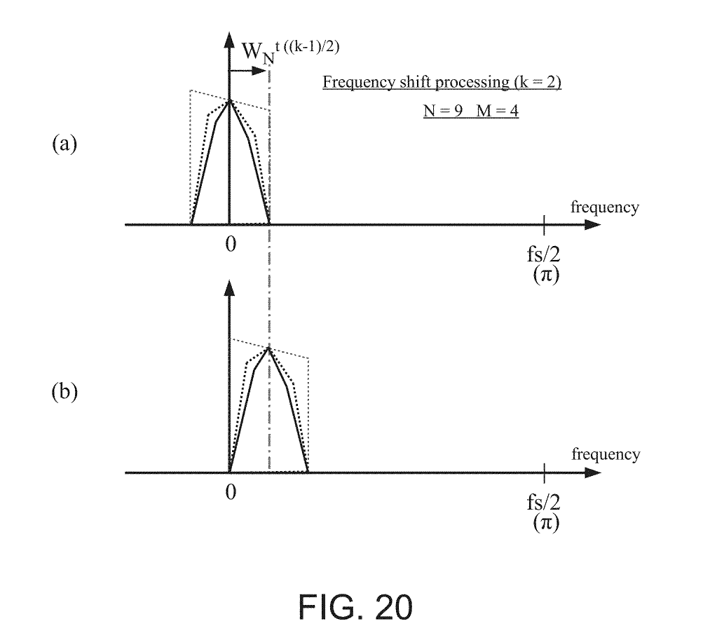

FIGS. 19 and 20 are diagrams for explaining processing performed by the audio data inference apparatus INF, and schematically show frequency spectra of signals at respective processing stages (frequency region R2, k=2).

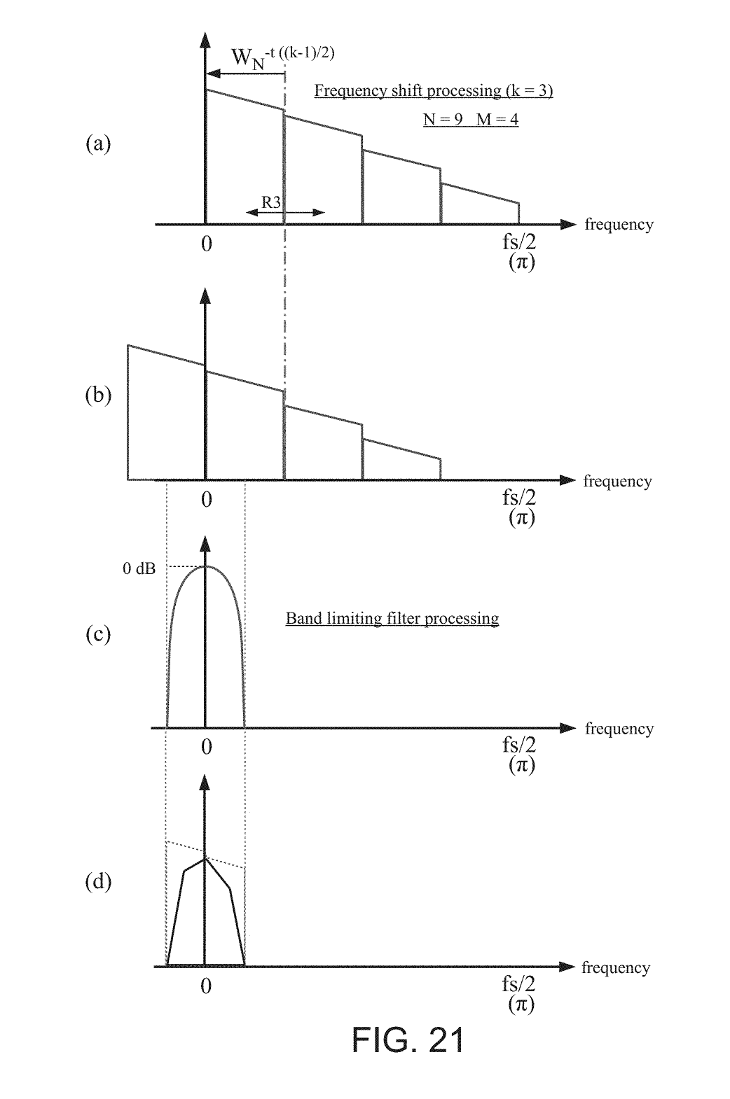

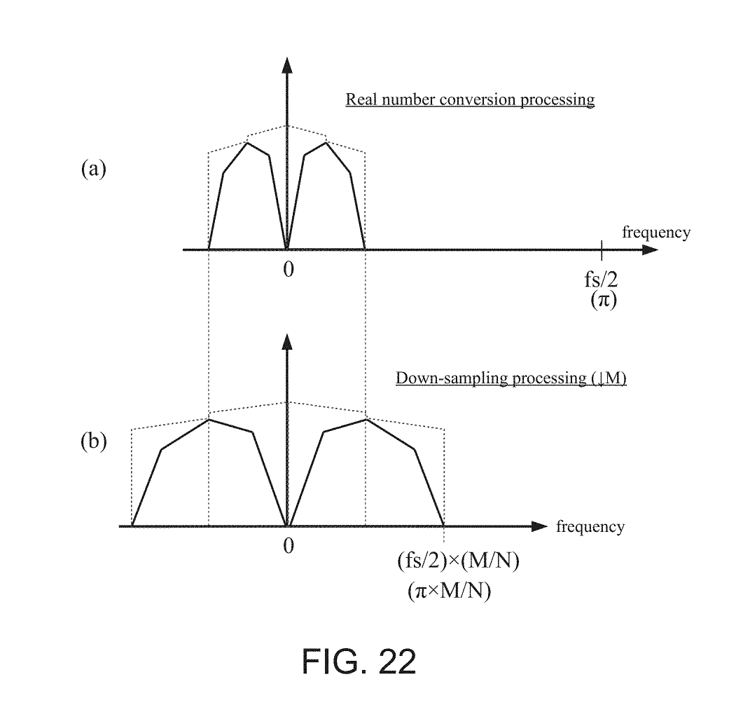

FIGS. 21 and 22 are diagrams for explaining processing performed by the audio data learning apparatus DL, and schematically show the frequency spectra of the signal at each processing stage (frequency region R3, k=3).

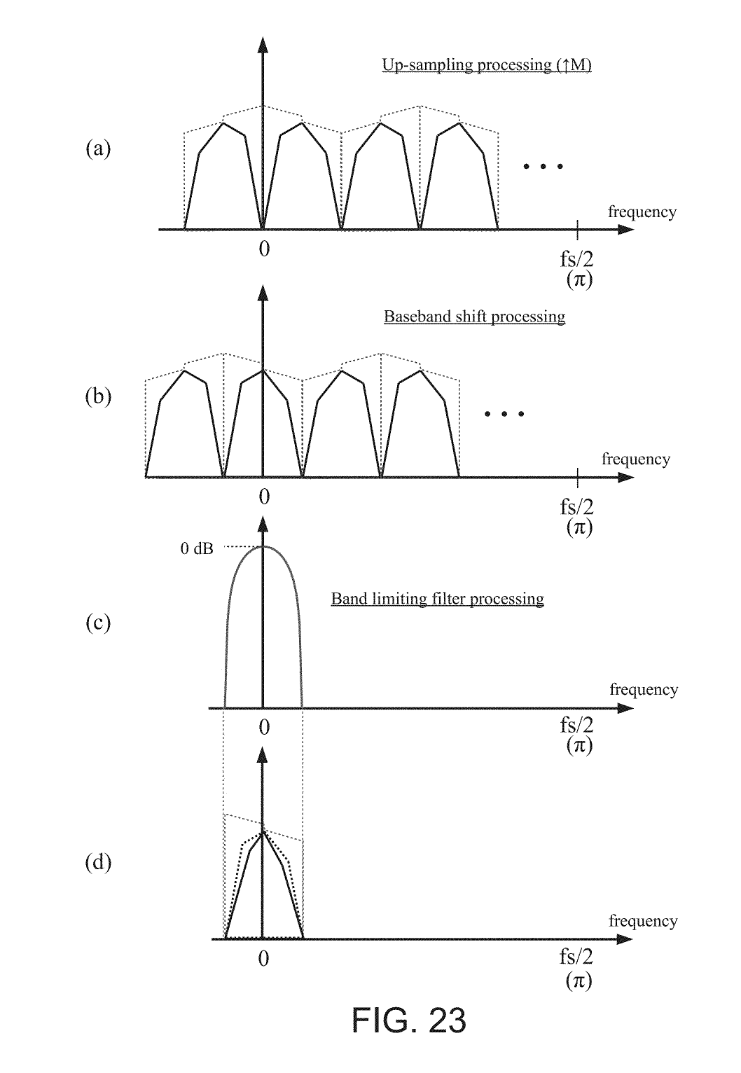

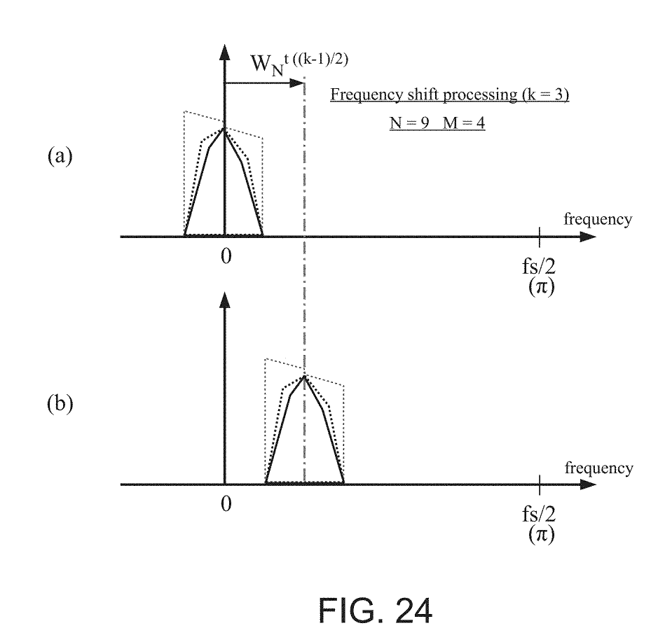

FIGS. 23 and 24 are diagrams for explaining processing performed by the audio data inference apparatus INF, and schematically show the frequency spectra of the signal at each processing stage (frequency region R3, k=3).

Hereinafter, description will be made with reference to the flowchart of FIG. 6.

<<Learning Processing>>

### Step S1:

Input data x (for example, waveform data of a full band audio signal) is inputted into the subband dividing unit 1 of the audio data learning apparatus DL. More specifically, as shown in FIG. 3, the input data x (signal x(t)) is inputted into the first frequency shift processing unit 111 to the N-th frequency shift processing unit 11N of the subband dividing unit 1.

### Step S2:

Next. the first frequency shift processing unit 111 to the N-th frequency shift processing unit 11N each perform frequency shift processing on the input signal x(t).

More specifically, the k-th frequency shift processing unit 11k performs processing corresponding to

xₖ(t)=x(t)×W_{N}^{-t((k-1)/2)}

W_{N}=exp(j×2π/(2N))

where k is a natural number satisfying 1≤k≤N and j is the imaginary unit, thereby obtaining the signal xₖ(t) after frequency shift processing.

In a case of k=1, W_{N}^{-t((k-1)/2)}=0 is satisfied, and thus xₖ(t)=x(t) is satisfied.

FIG. 13(b) is a diagram showing spectra of the signal xₖ(t) after frequency shift processing when k=1 is satisfied (processing target region R1).

FIG. 17(b) is a diagram showing spectra of the signal xₖ(t) after frequency shift processing when k=2 is satisfied (processing target region R2).

FIG. 21(b) is a diagram showing spectra of the signal xₖ(t) after frequency shift processing when k=3 is satisfied (processing target region R3).

### Step S3:

The first band limiting filter processing unit 121 to the N-th band limiting filter processing unit 12N each perform band limiting filter processing on the input data x_shftₖ (the signal xₖ(t)).

More specifically, the k-th band limiting filter processing unit 12k performs band limitation with a band limiting filter having square root cosine characteristics, which corresponds to the following:

(1) when −π/(N−1)≤ω≤π/(N−1) is satisfied Formula 7

$$H ( ω ) = \sqrt{cos ( \frac{N - 1}{2} ω )} \qquad Formula 7$$

(2) when ω<−π/(N−1) or ω>π/(N−1) is satisfied

H (ω)=0

ω: angular frequency.

Note that letting h(t) be an impulse response of the band limiting filter having the above-described square root cosine characteristics, the k-th band limiting filter processing unit 12k performs processing corresponding to the following, thereby obtaining a signal x_{k, pp}(t) after band limitation processing.

x_{k,pp}(t)=h(t)*xₖ(t)

Note that “*” is an operator that takes a convolution sum.

As a result, the k-th band limiting filter processing unit 12k obtains data x_ftₖ after band limitation processing as

x_ftₖ=[x_{k,pp}(1), . . . ,x_{k,pp}(T)].

The k-th band limiting filter processing unit 12k then transmits the obtained data x_ftₖ to the k-th real number conversion processing unit 13k.

FIG. 13(c) shows frequency characteristics of the above-described band limiting filter. It is assumed that the frequency f is a normalized frequency and f=2π is satisfied when the frequency f is the same as the sampling frequency fs.

FIG. 13(d) shows frequency spectra (a portion indicated by solid lines) of the signal x_{k, pp}(t) after band limiting filter processing is performed by the band limiting filter having the frequency characteristics of FIG. 13(c) when k=1 is satisfied (processing target region R1).

FIG. 17(d) shows frequency spectra (a portion indicated by solid lines) of the signal x_{k, pp}(t) after band limiting filter processing is performed by the band limiting filter having the frequency characteristics of FIG. 17(c) when k=2 is satisfied (processing target region R2).

FIG. 21(d) shows frequency spectra (a portion indicated by solid lines) of the signal x_{k, pp}(t) after band limiting filter processing is performed by the band limiting filter having the frequency characteristics of FIG. 21(c) when k=3 is satisfied (processing target region R3).

### Step S4:

Next, the first real number conversion processing unit 131 to the N-th real number conversion processing unit 13N each perform real number conversion processing on the received data x_ftₖ (signal x_{k, pp}(t)).

More specifically, the k-th real number conversion processing unit 13k performs SSB modulation processing. In other words, the k-th real number conversion processing unit 13k performs processing corresponding to the following, thereby obtaining a signal x_{k, SSB}(t) after real number conversion processing.

x_{k,SSB}(t)=x_{k,pp}(t)×W_{N}^{1/2}+x*_{k,pp}(t)×W_{N}^{-t/2}

As a result, the k-th real number conversion processing unit 13k obtains the data x_subₖ after real number conversion processing as

x_subₖ=[x_{k,SSB}(1), . . . ,x_{k,SSB}(T)].

The k-th real number conversion processing unit 13k then transmits the obtained data x_subₖ to the k-th down-sampling processing unit 2k.

FIG. 14(a) shows frequency spectra of the signal x_{k, SSB}(t) after real number conversion processing when k=1 is satisfied (processing target region R1).

FIG. 18(a) shows frequency spectra of signals x_{k, SSB}(t) after real number conversion processing when k=2 is satisfied (processing target region R2).

FIG. 22(a) shows frequency spectra of signals x_{k, SSB}(t) after real number conversion processing when k=3 is satisfied (processing target region R3).

### Step S5:

Next, the first down-sampling processing unit 21 to the N-th down-sampling processing unit 2N each perform down-sampling processing (decimating processing) with a thinning rate of M (M is a natural number) on the received data x_subₖ (signal x_{k, SSB}(t)) to obtain data x_dₖ after the processing.

As a result, the k-th down-sampling processing unit 2k obtains data x_dₖ after down-sampling processing as

x_dₖ=[x_{k,SSB}(M), . . . ,x_{k,SSB}(T×M)].

The k-th down-sampling processing unit 2k transmits the obtained data x_dₖ to the k-th subband learning model 3k.

FIG. 14(b) shows frequency spectra of the signals x_{k, SSB}(t×M) after down-sampling processing when k=1 is satisfied (processing target region R1).

FIG. 18(b) shows frequency spectra of the signals x_{k, SSB}(t×M) after down-sampling processing when k=2 is satisfied (processing target region R2).

FIG. 22(b) shows frequency spectra of the signals x_{k, SSB}(t×M) after down-sampling processing when k=3 is satisfied (processing target region R3).

### Step S6:

Next, the first learning model 31 to the N-th subband learning models 3N of the subband learning model unit 3 each perform model learning using the auxiliary input h and the corresponding subband signal data among the subband signal data x_d₁ to x_d_{N} after down-sampling processing respectively transmitted from the first down-sampling processing unit 21 to the N-th down-sampling processing unit 2N. Note that the input of the auxiliary input h may be omitted.

The process in step S6 is the same as the process in the first embodiment. However, in the first embodiment, a case of N=4 is described, but in the present embodiment a case of N=9 will be described.

<<Inference Processing>>

Assuming that in the inference processing in the present embodiment, the same signal as in the first embodiment is inputted into the audio data inference apparatus INF, the inference processing of the present embodiment will now be described with reference to the flowchart of FIG. 9.

### Step S21:

The auxiliary input h and the subband signal data xaₖ constituting input data x′ in performing inference processing are inputted into the subband learned model unit 3A of the audio data inference apparatus INF.

Note that the subband signal data xaₖ is similar to a signal obtained by performing the same processing as above by the subband dividing unit 1 and the down-sampling processing unit 2 on the input data x′ (signal x′(t)). Thus, a signal obtained by inputting the input data x′ (signal x′(t)) into the subband dividing unit 1 and performing the same processing as above by the subband dividing unit 1 and the down-sampling processing unit 2 may be inputted into the subband learned model unit 3A as subband signal data xaₖ.

Note that the data inputted into the k-th subband learned model 3Ak is data of at least one of the auxiliary input h and the subband signal data xaₖ.

### Step S22:

The k-th subband learned model 3Ak (k is a natural number satisfying 1≤k≤N) performs processing using the k-th subband learned model 3Ak on the auxiliary input h and the subband signal data xaₖ to obtain data after the processing as data xbₖ. The processing of the k-th subband learned model 3Ak is the same as that of the first embodiment. In the second embodiment, a case of N=9 is described.

The data xb₁ (signals xb₁(t)) to xb_{N} (signal xb_{N}(t)) respectively obtained in the first subband learned model 3A1 to the N-th subband learned model 3AN are transmitted from the subband learned model unit 3A to the up-sampling processing unit 4.

### Step S23:

Next, the first up-sampling processing unit 41 to the N-th up-sampling processing unit 4N each perform oversampling processing (e.g, perform up-sampling processing by zero insertion) by up-sampling the received data xbₖ (signal xbₖ(t)) with a thinning rate of M to obtain data xcₖ (signal xcₖ(t)) after up-sampling processing.

FIG. 15(a) shows frequency spectra of the signal xcₖ(t) after up-sampling processing when k=1 is satisfied (processing target region R1).

FIG. 19(a) shows frequency spectra of the signal xcₖ(t) after up-sampling processing when k=2 is satisfied (processing target region R2).

FIG. 23(a) shows frequency spectra of the signal xcₖ(t) after up-sampling processing when k=3 is satisfied (processing target region R3).

### Step S24:

Next, the first baseband shift processing unit 511 to the N-th baseband shift processing unit 51N of the subband synthesis unit 5 each perform baseband shift processing on the received data xcₖ (signal xcₖ(t)) after up-sampling processing.

More specifically, the k-th baseband shift processing unit 51k performs processing corresponding to the following to obtain a signal xc_bsₖ(t) after baseband shift processing.

xc_bsₖ(t)=xcₖ(t)×W_{N}^{-1/2}

W_{N}=exp(j×2π/(2N))

k: a natural number satisfying 1≤k≤N

j: the imaginary unit

The k-th baseband shift processing unit 51k then transmits the obtained data xc_bsₖ (signal xc_bsₖ(t)) to the k-th band limiting filter processing unit 52k.

FIG. 15(b) shows frequency spectra of the signal xc_bsₖ(t) after baseband shift processing when k=1 is satisfied (processing target region R1).

FIG. 19(b) shows frequency spectra of the signal xc_bsₖ(t) after baseband shift processing when k=2 is satisfied (processing target region R2).

FIG. 23(b) shows frequency spectra of the signal xc_bsₖ(t) after baseband shift processing when k=3 is satisfied (processing target region R3).

### Step S25:

Next, the first band limiting filter processing unit 521 to the N-th band limiting filter processing unit 52N each perform the band limiting filter processing on the received data xc_bsₖ (the signal xc_bsₖ(t)).

More specifically, the k-th band limiting filter processing unit 52k performs band limiting with a band limiting filter having square root cosine characteristics represented as follows.

(1) If −π/(N−1)≤ω≤/(N−1) is satisfied, then

$$H ( ω ) = \sqrt{cos ( \frac{N - 1}{2} ω )} \qquad Formula 8$$

(2) If ω<−π/(N−1) or ω>π/(N−1) is satisfied, then

H(ω)=0

ω: angular frequency

Note that the k-th band limiting filter processing unit 52k performs processing corresponding to

xc_ftₖ(t)=h(t)*xc_bsₖ(t)

where h(t) is an impulse response of the band limiting filter having square root cosine characteristics, thereby obtaining a signal xc_ftₖ(t) after band limitation processing. Note that “*” is an operator that takes a convolution sum.

The k-th band limiting filter processing unit 52k then transmits the obtained data xc_ftₖ (signal xc_ftₖ(t)) to the k-th frequency shift processing unit 53k.

FIG. 15(c) shows frequency characteristics of the above-described band limiting filter.

FIG. 15(d) shows frequency spectra of the signal xc_ftₖ(t) after performing band limiting filter processing by a band limiting filter having frequency characteristics shown in FIG. 15(c) in a case of k=1 (processing target region R1).

FIG. 19(d) shows frequency spectra of the signal xc_ftₖ(t) after performing band limiting filter processing by a band limiting filter having frequency characteristics shown in FIG. 19(c) in a case of k=2 (processing target region R2).

FIG. 23(d) shows frequency spectra of the signal xc_ftₖ(t) after performing band limiting filter processing by a band limiting filter having frequency characteristics shown in FIG. 23(c) in a case of k=3 (processing target region R2).

### Step S26:

Next, the first frequency shift processing unit 531 to the N-th frequency shift processing unit 53N each perform frequency shift processing on the received signal xc_ftₖ(t).

More specifically, the k-th frequency shift processing unit 53k performs processing corresponding to the following, thereby obtaining a signal xc_shftₖ(t) after frequency shift processing.

xc_shftₖ(t)=xc_ftₖ(t)×W_{N}^{t((k-1)/2)}

W_{N}=exp(j×2π/(2N))

k: a natural number satisfying 1≤k≤N

j: the imaginary unit

The k-th frequency shift processing unit 53k then transmits the obtained data xc_shftₖ (signal xc_shftₖ(t)) to the subband synthesis processing unit 54.

Note that FIG. 16(b) shows frequency spectra of the signal xc_shftₖ(t) after frequency shift processing when k=1 is satisfied (processing target region R1). The frequency shift processing when k=1 is satisfied is performed by the first frequency shift processing unit 531. The frequency shift amount in the k-th frequency shift processing unit 53k is W_{N}^{((k-1)/2)}. and therefore the frequency spectra of the signal after the processing in the k-th frequency shift processing unit 53k return to the position of the frequency spectra of the original subband signal (original signal).

FIG. 20(b) shows frequency spectra of the signal xc_shftₖ(t) after frequency shift processing when k=2 is satisfied (processing target region R2).

FIG. 24(b) shows frequency spectra of the signal xc_shftₖ(t) after frequency shift processing when k=3 is satisfied (processing target region R3).

### Step S27:

The subband synthesis processing unit 54 receives data xc_shft₁ to xc_shft_{N} respectively transmitted from the first frequency shift processing unit 531 to the N-th frequency shift processing unit 53N and performs synthesis processing (addition processing) on the received data xc_shft₁ to xc_shft_{N} to obtain output data xo (signal xo(t)).

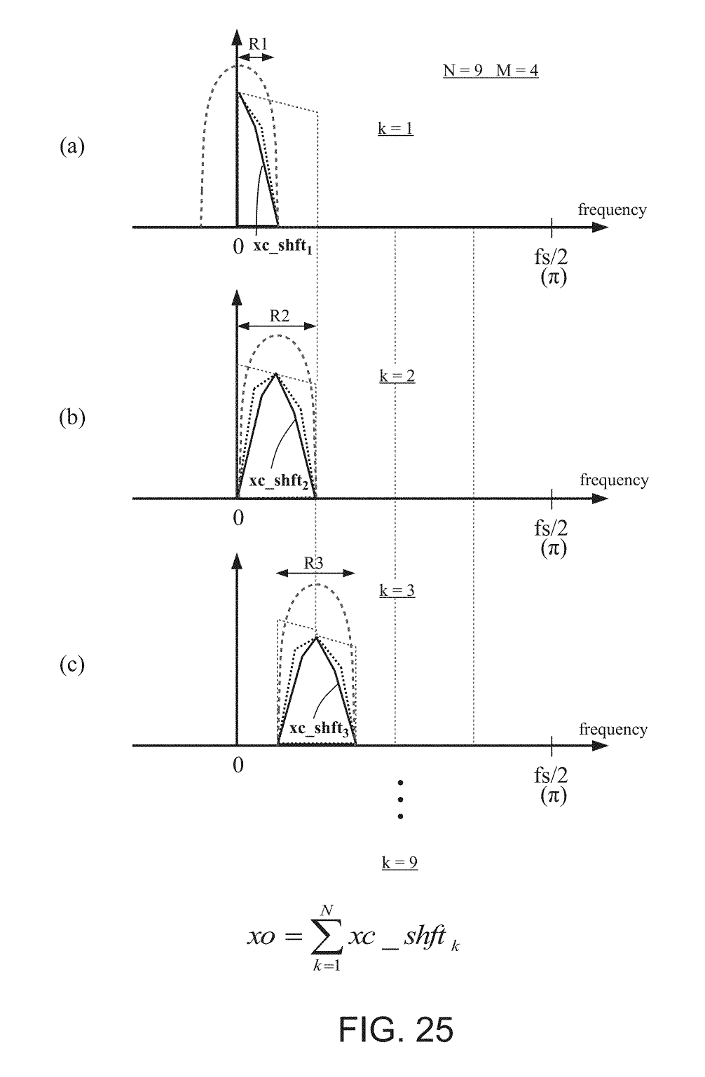

FIG. 25(a) shows the signal xc_shftₖ(t) after frequency shift processing when k=1 is satisfied (processing target region R1).

FIG. 25(b) shows the signal xc_shftₖ(t) after frequency shift processing when k=2 is satisfied (processing target region R2).

FIG. 25(c) shows the signal xc_shftₖ(t) after frequency shift processing when k=3 is satisfied (processing target region R3).

Similarly, the signal xc_shftₖ(t) after frequency shift processing in a case of k=4 to 9 (processing target areas R4 to R 9) is obtained.

The subband synthesis processing unit 54 performs processing corresponding to the following formula to obtain output data xo (output signal xo(t)).

$$xo = {\sum }_{k = 1}^{N} {xc}_{—} {shft}_{k} \qquad Formula 9$$

As described above, the audio data learning apparatus DL of the audio data processing system of the present embodiment divides the full band waveform data (full band audio signal) into subband signals by performing band limiting processing with a filter having square root cosine characteristics, and the subband learning model unit 3 performs learning (optimization) using the subband signals obtained by dividing the full band waveform. N models (the first subband learning model to the N-th subband learning model) in the subband learning model unit 3 allows for performing, in parallel, learning (optimization) of a model using subband signals. In other words, the audio data learning apparatus DL achieves learning (optimization) of the raw audio generative model using parallel processing.

In addition, in the audio data inference apparatus INF of the audio data processing system of the present embodiment, the inference processing that is performed in parallel is achieved by the subband learned model unit 3A that receives at least one of the auxiliary input h and the subband signal. In other words, using N subband learned models (first to N-th subband learned models) in the subband learned model unit 3A allows for performing inference processing on subband signals in parallel. The audio data inference apparatus INF performs up-sampling processing on the inference result data of the N subband learned models (the first to the N-th subband learned models) and then performs the band synthesis processing including band limiting processing with a filter having square root cosine characteristics, thereby obtaining the processing result data of the inference processing on the full band audio data.

In other words, the audio data inference apparatus INF achieves inference processing of the raw audio generative model using parallel processing. As a result, the inference processing in the audio data inference apparatus INF is performed much faster than the inference processing with the raw audio generative model using the full band waveform data as in the conventional technique.

Furthermore, the audio data processing system of the present embodiment performs learning of the model using subband signals obtained by performing band limiting processing with a filter having square root cosine characteristics, thus allowing for performing model-learning more appropriately than performing model-learning using the full band waveform data as in the conventional technique. When learning a model using full band waveform data as in the conventional technique, learning is performed so that the S/N ratio becomes maximum with respect to time series data (signal). This causes errors to be uniformly present for all frequencies, resulting in deterioration of sound quality. In particular, when learning a model using full band waveform data, errors in the high frequency region tend to become large, so that waveform data (audio signal) obtained by performing inference processing with the model learned using full band waveform data becomes data in which its spectra in high frequency region greatly deviate from correct spectra that should originally exist in the high frequency region. This causes deterioration of sound quality.

In contrast to that, the audio data processing system of the present embodiment performs learning of a model using subband signals obtained by performing band-limiting filter processing with a filter having square root cosine characteristics on the subband signal (full band audio signal). In other words, the audio data processing system of the present embodiment performs model-learning using a subband signal forcibly colorized, that is, a signal easy to predict, thus allowing for performing model-learning more appropriately than performing model-learning using the full band waveform data as in the conventional technique.

The audio data inference apparatus INF of the audio data processing system of the present embodiment performs inference processing using the learned model obtained as described above, so that waveform data (audio signal) obtained by performing the inference processing becomes data in which its spectra in high frequency region does not greatly deviate from correct spectra that should originally exist in the high frequency region. As a result, the waveform data (audio signal) obtained by the audio data inference apparatus INF of the audio data processing system of the present embodiment is very high quality waveform data (audio signal).

In addition, the audio data processing system of the present embodiment performs subband synthesis processing by performing band limiting processing with the filter having square root cosine characteristics shown in FIG. 12 for each frequency region shown in FIG. 12 both in learning and in inferring, thus appropriately restoring (estimating) the original signal with almost no energy loss as compared with its original signal.

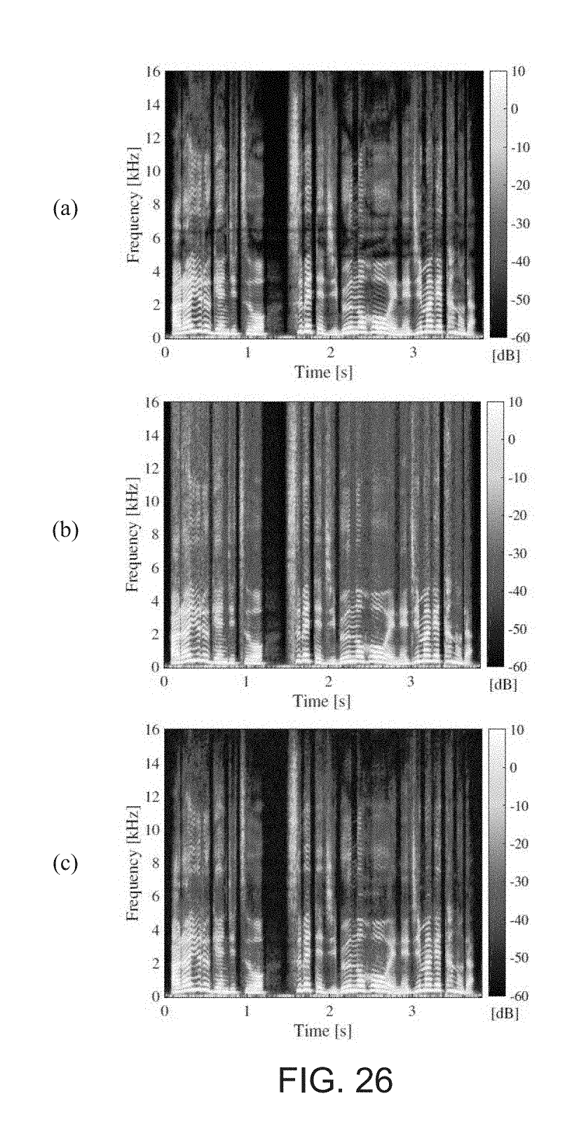

FIG. 26 shows (1) a spectrogram of an original signal (FIG. 26(a)), (2) a spectrogram of an output signal (signal after inference processing) of a learned model obtained by learning using full band waveform data as it is without performing subband division (FIG. 26(b)), and (3) a spectrogram of an output signal (signal after inference processing) by the audio processing system of the present embodiment (FIG. 26 (c)).

Note that data in FIG. 26 is data obtained under the following conditions.

(1) 7242 sentences (about 4.8 hours) of Japanese female speaker and 5697 sentences (about 3.7 hours) of male speakers were set as learning sets, each set including 100 sentences thereof was set as a test set. Recorded sound whose sampling frequency is fs=48 kHz was down-sampled to data of 32 kHz.
(2) Learning and generation (inference) using the raw audio generative model without conditions are performed.

x′(t) is estimated from the correct answer input [x(1), . . . , x(t−1)] without using the auxiliary input h and the generated sample x′=[x′(1), . . . , x′(T)] is assumed to be outputted.

As can be seen from FIG. 26, large errors in high frequency region (e.g., region of 10 kHz or more) occur in the spectrogram (FIG. 26(b)) of the output signal (signal after inference processing) by the learned model obtained by learning using the full band waveform data (spectra components in high frequency regions is too large as compared with those of the original signal). This causes degradation of sound quality.

In contrast to that, the spectrogram (FIG. 26(c)) of the output signal (signal after inference processing) by the audio processing system of the present embodiment is very close to the spectrogram of the original signal (FIG. 26(a)). In other words, it is understood that the output signal (signal after inference processing) by the audio processing system of the present embodiment is very close to the original signal (correct solution data), and thus very good inference processing is able to be performed.

As described above, the audio data processing system of the present embodiment performs audio data processing using the raw audio generative model at high speed, and obtains extremely high quality audio data.

### Third Embodiment

Next, a third embodiment will be described.

The components in the present embodiment that are the same as the components described in the above embodiment will be given the same reference numerals as those components and will not be described in detail.

In an audio data processing system using subband processing, a phase shift between bands caused by random sampling in inferring (e.g., in generating audio) is a problem.

The audio data processing system 3000 of the third embodiment includes a structure in which multiple bands are to be inputted, thereby appropriately preventing a phase shift between bands from occurring.

3.1: Configuration of Audio Data Processing System

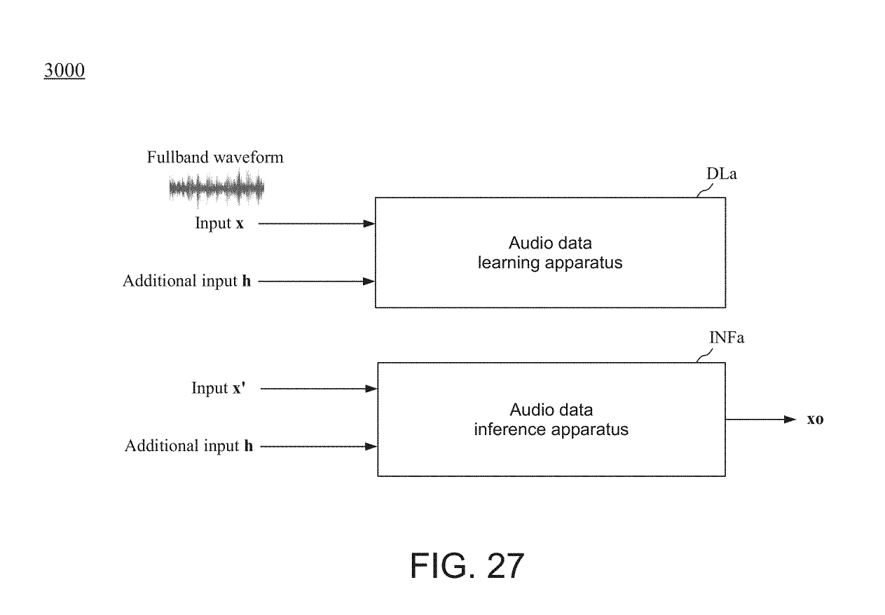

FIG. 27 is a schematic diagram showing the structure of an audio data processing system 3000 according to the third embodiment.

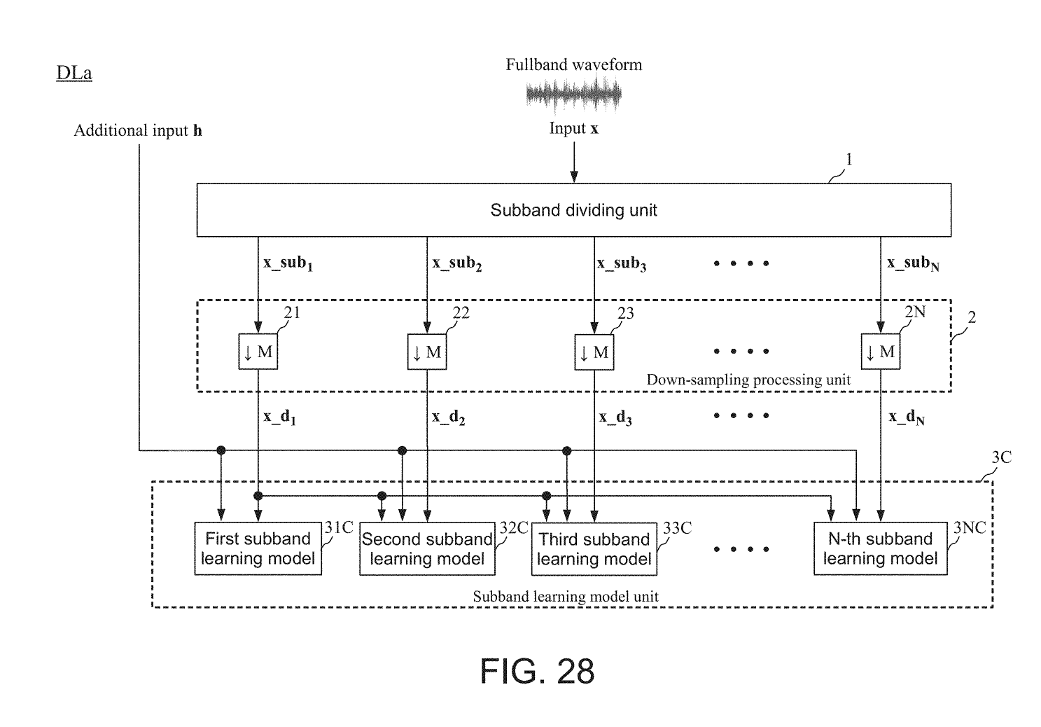

FIG. 28 is a schematic diagram showing the structure of an audio data learning apparatus DLa of the audio data processing system 3000 according to the third embodiment.

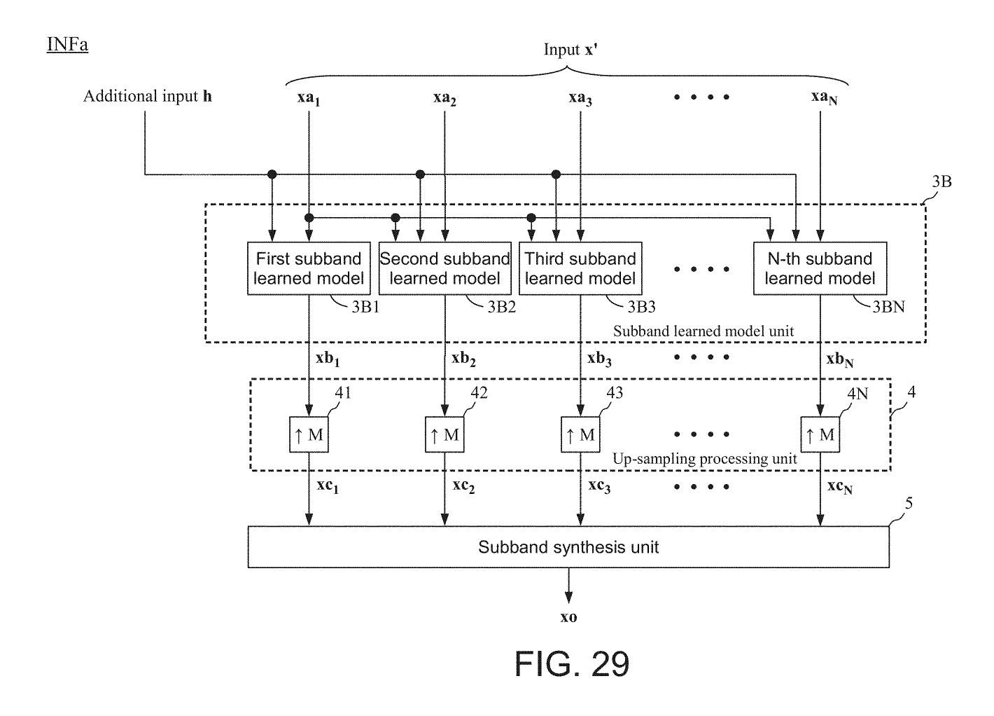

FIG. 29 is a schematic diagram showing the structure of an audio data inference apparatus INFa of the audio data processing system 3000 according to the third embodiment.

3.1.1: Configuration of Audio Data Learning Apparatus

As shown in FIG. 27, the audio data processing system 3000 includes the audio data learning apparatus DLa and the audio data inference apparatus INFa.

As shown in FIG. 28, the audio data learning apparatus DLa includes a subband learning model unit 3C replacing the subband learning model unit 3 of the audio learning apparatus DL of the first embodiment.

As shown in FIG. 28, the subband learning model unit 3C includes a first subband learning model 31C to an N-th subband learning model 3NC.

The first subband learning model 31C receives an auxiliary input h and subband signal data x_d₁ after_down-sampling processing transmitted from the first down-sampling processing unit 21.

A second subband learning model 32C to an N-th subband learning model 3NC are each able to receive the auxiliary input h and subband signal data x_d₂ to x_d_{N} after down-sampling processing respectively transmitted from a second down-sampling processing unit 22 to an N-th down-sampling processing unit 2N. In addition, subband signal data x_d₁ after down-sampling processing transmitted from the first down-sampling processing unit 21 is inputted into each of the second subband learning model 32C to the N-th subband learning model 3NC.

The first subband learning model 31C to the N-th subband learning model 3NC each perform model-learning using the received data and the auxiliary input h to optimize each model (to obtain parameters to optimize each model). In other words, the k-th subband learning model 3kC (k is a natural number satisfying 1≤k≤N) performs model-learning using (1) subband signal data x_dₖ, (2) subband signal data x_d₁, and (3) the auxiliary input h to optimize each model.

Note that the k-th subband learning model 3kC may perform model-learning only using the received data (subband signal data x_dₖ and subband signal data x_d₁) without receiving the auxiliary input h.

3.1.2: Configuration of Audio Data Inference Apparatus

As shown in FIG. 29, the audio data inference apparatus INFa includes a subband learned model unit 3B, an up-sampling processing unit 4, and a subband synthesis unit 5.

As shown in FIG. 29, the audio data inference apparatus INFa includes a subband learned model unit 3B replacing the subband learned model unit 3A of the audio data inference apparatus INF of the first embodiment.

As shown in FIG. 29, the subband learned model unit 3B includes a first subband learned 3B1 to an N-th subband learned model 3BN. The subband learned model unit 3B1 to the N-th subband learned model 3BN are each optimized models obtained by model-learning with the first subband learning model 31C to the N-th subband learning model 3NC (models in which optimized parameters obtained by model-learning are set).

As shown in FIG. 29, the first subband learned model 3B1 receives the auxiliary input h and subband signal data xa₁ constituting input data x′ in inferring, performs processing using the first subband learned model 3B1 on the received data, and transmits data after processing as data xb₁ to the first up-sampling processing unit 41. Note that data inputted into the first subband learned model 3B1 is at least one of the auxiliary input h and the subband signal data xa₁.

As shown in FIG. 29, the k-th subband learned model 3Bk (k is a natural number satisfying 2≤k≤N) receives (1) the auxiliary input h, (2) subband signal data xaₖ constituting the input data x′ in inferring, and (3) subband signal data xa₁ constituting the input data x′ in inferring, performs processing using the k-th subband learned model 3Bk on the received data, and transmits data after processing as data xbₖ to the k-th up-sampling processing unit 4k. Note that data inputted into the k-th subband learned model 3Bk may be the subband signal data xa₁ and at least one of the auxiliary input h and subband signal data xaₖ.

3.2: Operation of Audio Data Processing System

The operation of the audio data processing system 3000 with the above-described structure will now be described.

For operations performed in the audio data processing system 3000, (1) learning processing by the audio data learning apparatus DLa, and (2) inference processing by the audio data inference apparatus INFa will now be described separately.

3.2.1: Learning Processing

Similar to the first embodiment, the audio data processing system 3000 performs processing of steps S1 to S5 shown in FIG. 6.

### Step S6:

In step S6, the first subband learning model 31C of the subband learning model unit 3C performs model-learning using the auxiliary input h and subband signal data x_d₁ after down-sampling processing transmitted from the first down-sampling processing unit 21. Note that the input of the auxiliary input h may be omitted.

The k-th subband learning model 3kC (k is a natural number satisfying 2≤k≤N) of the subband learning model unit 3C performs model-learning using (1) subband signal data x_dₖ after down-sampling transmitted from the k-th down-sampling processing unit 2k, (2) the auxiliary input h, and (3) subband signal data x_d₁ after down-sampling transmitted from the first down-sampling processing unit 21. Note that the input of the auxiliary input h may be omitted.

Similar to the first embodiment, in the audio data learning apparatus DLa of the present embodiment, using subband signals obtained by dividing the received full band waveform signal into subbands allows parallel processing to be easily performed, thereby achieving high-speed processing.

The first subband learning model 31C performs model-learning using a model in which conditional probability p(x_d₁|h) is set as below using the auxiliary input h such as a context label or the like, and data x_d₁ obtained by the first down-sampling processing unit 21.

$$p ( {x}_{—} {d}_{l} \vert h ) = {\prod }_{t = l}^{T \text{/} M} p ( {x}_{—} {d}_{l} ( t ) \vert {x}_{—} {d}_{l} ( l ) , ⋯ , {x}_{—} {d}_{l} ( t - l ) , h ) \qquad Formula 10$$

Note that when t=1 is satisfied, p(x_d₁(t)|x_d₁(1), . . . , x_d₁(t−1), h) may be set to p(x_d₁(1)|h).

Also, x_d₁(1)=x_{1,SSB}(M) and x_d₁(t)=x_{1,SSB}(t×M) are satisfied. In other words, the first subband learning model 31C needs only one M-th (i.e., 1/M times) as much as an amount of target data for obtaining the conditional probability p(x_d₁|h) needed in using the full band waveform data, which is, for example, used in the conventional technique.

The first subband learning model 31C then optimizes parameters of the model so that the above-described conditional probability is maximum. In other words, the first subband learning model 31C performs optimization processing of the model (model-learning) by obtaining optimized parameters θₒₚₜ_{_}₁ through processing corresponding to the following:

$${θ}_{{opt}_{—} l} = {argmax}_{{θ}_{1}} p ( {x}_{—} {d}_{l} \vert h ; {θ}_{1} ) \qquad Formula 11$$

Parameter θ₁ is a scalar, a vector, or a tensor.

To obtain the optimized parameter θₒₚₜ_{_}₁, instead of processing as described above (processing using “argmax”), the optimized parameter θₒₚₜ_{_}₁ may be obtained by obtaining output data by performing random sampling based on the conditional probability p(x_d₁|h) (e.g., by selecting output data by randomly sampling data from a plurality of pieces of data for which p(x_d|h) is greater than or equal to a predetermined value) and by evaluating the output data using a predetermined evaluation function, for example.

As described above, the first subband learning model 31C of the subband learning model unit 3C performs learning processing.

The k-th subband learning model 3kC (k is a natural number satisfying 2≤k≤N) performs model-learning using a model in which the conditional probability p(x_dₖ|h) is set as below using the auxiliary input h such as a context label or the like, data x_dₖ obtained by the k-th down-sampling processing unit 2k. and data x_d₁ obtained by the first down-sampling processing unit 21.

$$p ( {x}_{—} {d}_{k} \vert h ) = {\prod }_{t = 1}^{T \text{/} M} p ( {x}_{—} {d}_{k} ( t ) \vert {x}_{—} {d}_{k} ( 1 ) , ⋯ , {x}_{—} {d}_{k} ( t - 1 ) , h , {x}_{—} {d}_{1} ( 1 ) , ⋯ , {x}_{—} {d}_{1} ( t - 1 ) ) \qquad Formula 12$$

Note that when t=1 is satisfied, p(x_dₖ(t)|x_dₖ(1), . . . , x_dₖ(t−1), h, x_d₁(1), . . . , x_d₁(t−1)) may be set to p(x_dₖ(1)|h).

Also, x_dₖ(1)=x_{k,SSB}(M) and x_dₖ(t)=x_{k,SSB}(t×M) are satisfied.

The k-th subband learning model 3kC then optimizes parameters of the model so that the above-described conditional probability is maximum. In other words, the k-th subband learning model 3kC performs optimization processing of the model (model-learning) by obtaining optimized parameters θₒₚₜ_{_}ₖ through processing corresponding to the following:

$${θ}_{{opt}_{—} k} = {argmax}_{{θ}_{k}} p ( {x}_{—} {d}_{k} \vert h ; {θ}_{k} ) \qquad Formula 13$$

Parameter θₖ is a scalar, a vector, or a tensor.

To obtain the optimized parameter θₒₚₜ_{_}ₖ, instead of processing as described above (processing using “argmax”), the optimized parameter θₒₚₜ_{_}ₖ may be obtained by obtaining output data by performing random sampling based on the conditional probability p(x_dₖ|h) (e.g., by selecting output data by randomly sampling data from a plurality of pieces of data for which p(x_dₖ|h) is greater than or equal to a predetermined value) and by evaluating the output data using a predetermined evaluation function, for example.

As described above, the k-th subband learning model 3kC of the subband learning model unit 3C performs learning processing.

3.2.2: Inference Processing

Next. inference processing by the audio data inference apparatus will be described.

In one example, a case in which a signal is divided into four subband signals (N=4) in the same manner as the first embodiment will be described with reference to the flowchart of FIG. 9.

### Step S21:

In step 21, the auxiliary input h and the subband signal data xa₁ constituting the input data x′ in inferring are inputted into the first subband learned model 3B1 of the subband learned model unit 3B.

Note that the subband signal data xa₁ is the same as a signal obtained by performing, on the input data x′ (signal x′(t)), the same processing as the above-described processing in the subband dividing unit 1 and the down-sampling processing unit 2. Thus, the input data x′ (signal x′(t)) may be inputted into the subband dividing unit 1, and a signal (signal transmitted from the down-sampling processing unit 2) obtained by performing the same processing as the above-described processing in the subband dividing unit 1 and the down-sampling processing unit 2 may be inputted into the subband learned model unit 3B as the subband signal data xa₁.

Note that data inputted into the first subband learned model 3B1 is at least one of the auxiliary input h and the subband signal data xa₁.

Also, the k-th subband learned model 3Bk (k is a natural number satisfying 2≤k≤N) of the subband learned model unit 3B of the audio data inference apparatus INFa receives (1) subband signal data xaₖ constituting input data x′ in inferring, (2) the auxiliary input h, and (3) subband signal data xa₁ constituting input data x′ in inferring.

Note that the subband signal data xaₖ is the same as a signal obtained by performing, on the input data x′ (signal x′(t)). the same processing as the above-described processing in the subband dividing unit 1 and the down-sampling processing unit 2. Thus, the input data x′ (signal x′(t)) may be inputted into the subband dividing unit 1, and a signal (signal transmitted from the down-sampling processing unit 2) obtained by performing the same processing as the above-described processing in the subband dividing unit 1 and the down-sampling processing unit 2 may be inputted into the subband learned model unit 3B as the subband signal data xaₖ.

Note that data inputted into the k-th subband learned model 3Bk may be the subband signal data xa₁ and at least one of the auxiliary input h and the subband signal data xaₖ.

### Step S22:

In step S22, the first subband learned model 3B1 of the subband learned model unit 3B performs processing on the auxiliary input h and the subband signal data xa₁ using the first learned model 3B 1 to obtain data after processing as data xb₁.

More specifically, xa₁(t) is assumed to be a discrete value within a range from 0 to 255, and a value for which the conditional probability p(xa₁|h) calculated with the following formula is maximum is determined to be a value of xa₁(t). Alternatively, a piece of data is selected from data for which the conditional probability p(xa₁|h) calculated with the following formula is greater than a predetermined value, and the selected data is determined to be a value of xa₁(t).

$$p ( {xa}_{l} \vert h ) = {\prod }_{t = l}^{T \text{/} M} p ( {xa}_{l} ( t ) \vert {xa}_{l} ( l ) , ⋯ , {xa}_{l} ( t - l ) , h ) \qquad Formula 14$$

Note that when t=1 is satisfied, p(xa₁(t)|xa₁(1), . . . , xa₁(t−1), h) may be set to p(xa₁(1)|h).

For example, when xa₁(t)=200 is satisfied and the conditional probability p(xa₁|h) obtained in the first subband learned model 3B1 is maximum, xa₁(t) is determined as xa₁(t)=200.

Alternatively, a piece of data is selected from a plurality of pieces of data for which the conditional probability p(xa₁|h) calculated by the first subband learned model 3B1 is greater than a predetermined value, and the selected data may be determined to be a value of xa₁(t).

Through the above-described processing, the first subband learned model 3C1 obtains output data xb₁ (signal sb₁(t)) transmitted from the first subband learned model 3B1, and then transmits the obtained data xb₁ (signal xb₁(1)) to the first up-sampling processing unit 41.

Note that the processing (inference processing) using the first subband learned model 3B1 is processing that uses subband signals obtained by performing down-sampling processing with a thinning rate of M on full band waveform data. Thus, an amount of the target data needed to obtain the conditional probability p(xa₁|h) is reduced to one M-th (i.e., 1/M times) as compared with a case using the full band waveform data as in the conventional technique.

This allows processing using N subband learned models to be performed at faster speed than processing using the full band waveform data as in the conventional technique.

Also, the k-th subband learned model 3Bk (k is a natural number satisfying 1≤k≤N) of the subband learned model unit 3B receives (1) the auxiliary input h, (2) subband signal data xaₖ, and (3) subband signal data xa₁, and then performs processing using the k-th subband learned model 3Bk on the received data to obtain data after processing as data xbₖ.

More specifically, each of xa₁(t) and xaₖ(t) are assumed to be a discrete value within a range from 0 to 255, and a value for which the conditional probability p(xaₖ|h) calculated with the following formula is maximum is determined to be a value of xaₖ(t). Alternatively, a piece of data is selected from data for which the conditional probability p(xaₖ|h) calculated with the following formula is greater than a predetermined value, and the selected data is determined to be a value of xaₖ(t).

$$p ( {xa}_{k} \vert h ) = {\prod }_{t = 1}^{T \text{/} M} p ( {xa}_{k} ( t ) \vert {xa}_{k} ( 1 ) , ⋯ , {xa}_{k} ( t - 1 ) , h , {xa}_{1} ( 1 ) , ⋯ , {xa}_{1} ( t - 1 ) ) \qquad Formula 15$$

Note that when t=1 is satisfied, p(xaₖ(t) xaₖ(1), . . . , xaₖ(t−1), h, xa₁(1), . . . , xa₁(t−1)) may be set to p(xaₖ(1)|h).

For example, when xaₖ(t)=200 is satisfied and the conditional probability p(xaₖ|h) is maximum, xaₖ(t) is determined as xaₖ(t)=200.

Alternatively, a piece of data is selected from a plurality of pieces of data for which the conditional probability p(xa₁|h) calculated by the first subband learned model 3B1 is greater than a predetermined value, and the selected data may be determined to be a value of xaₖ(t).

Through the above-described processing, the k-th subband learned model 3Ck obtains output data xbk (signal sbk(t)) transmitted from the k-th subband learned model 3Bk, and then transmits the obtained data xbk (signal xbk(t)) to the k-th up-sampling processing unit 4k.

Note that the processing (inference processing) using the k-th subband learned model 3Bk is processing that uses subband signals obtained by performing down-sampling processing with a thinning rate of M on full band waveform data.

This allows processing using N subband learned models to be performed at faster speed than processing using the full band waveform data as in the conventional technique.

### Steps S23 to S27:

In steps S23 to S27, the audio data inference apparatus INFa performs the same processing as processing in the first embodiment.

As described above, the audio data learning apparatus DLa of the audio data processing system 3000 divides the full band waveform data (full band audio signal) into subband signals, and performs model-learning (optimization) using the divided subband signals by the subband learning model unit 3C. Furthermore, the second subband learning model 32C to the N-th subband learning model 3NC of the subband learning model unit 3C commonly receive the subband signal data x_d₁ after down-sampling processing transmitted from the down-sampling processing unit 21, and the second subband learning model 32C to the N-th subband learning model 3NC perform learning using the subband signal data x_d₁ after down-sampling processing. In other words, N learning models in the subband learning model unit 3C perform learning using the subband signal data x_d₁ after down-sampling processing, which is commonly inputted into N learning models, thereby allowing for obtaining a learned model that transmits a signal in which a phase shift between bands is prevented from occurring.

In the audio data inference apparatus INFa of the audio data processing system 3000. the first subband learned model 3B 1 of the subband learned model unit 3B receives the auxiliary input h and the subband signal xa₁, whereas the k-th subband learned model 3Bk (k is a natural number satisfying 1≤k≤N) receives (1) the auxiliary input h, (2) the subband signal xaₖ, and (3) the subband signal xa₁. In other words, in the subband learned model unit 3B of the audio data inference apparatus INFa, the subband signal data xa₁ is commonly inputted into the N learned models, and then the inference processing is performed, thereby allowing for outputting a signal in which a phase shift between bands is prevented from occurring.

As described above, the structure of the audio data processing system 3000 in which multiple bands can be inputted appropriately prevents a shift between bands from occurring. In other words, the audio data processing system 3000 achieves appropriate phase compensation. As a result, the audio data processing system 3000 obtains much higher quality audio data.

Although the above embodiment describes the case in which the subband signal data after down-sampling processing that is commonly inputted into the N learning models of the subband learning model unit 3C is data x_d₁. the present invention should not be limited to this case. For example, the subband signal data after down-sampling processing that is commonly inputted into the N learning models of the subband learning model unit 3C may be any one piece of data among data x_d₁ to x_d_{N}. In addition, the number of the subband signal data after down-sampling processing that is commonly inputted into the N learning models of the subband learning model unit 3C should not be limited to one, and may be any number Num1 (Num1 is a natural number satisfying 2≤Num1≤N).

Although the above embodiment describes the case in which the subband signal data that is commonly inputted into the N learned models of the subband learned model unit 3B is data x_a₁, the present invention should not be limited to this case. For example, the subband signal data that is commonly inputted into the N learned models of the subband learned model unit 3B may be any one piece of data among data x_a₁ to x_a_{N}. In addition, the number of the subband signal data that is commonly inputted into the N learned models of the subband learned model unit 3B should not be limited to one, and may be any number Num2 (Num2 is a natural number satisfying 2≤Num2≤N).

For N models of the subband learning model unit 3C and N models of the subband learned model unit 3B in the audio data processing system 3000, models achieved using WaveNet disclosed in Non-Patent Document 1 may be employed.

Alternatively, for N models of the subband learning model unit 3C and N models of the subband learned model unit 3B in the audio data processing system 3000, models achieved using FFTNet disclosed in the following Document 1 may be employed.

### Document 1:

Z. Jin et al., FFTNet: A real-time speaker-dependent neural vocoder, in Proc. ICASSP, April 2018, pp. 2251-2255.

<<First Modification >>

Next, a first modification of the third embodiment will be described.

The components in the present modification that are the same as the components described in the above embodiment will be given the same reference numerals as those components and will not be described in detail.

In the audio data processing system of the first modification of the third embodiment, a case in which models disclosed in Document 1 (FFTNet model) are employed as N models of the subband learning model unit 3C and N models of the subband learned models will be described.

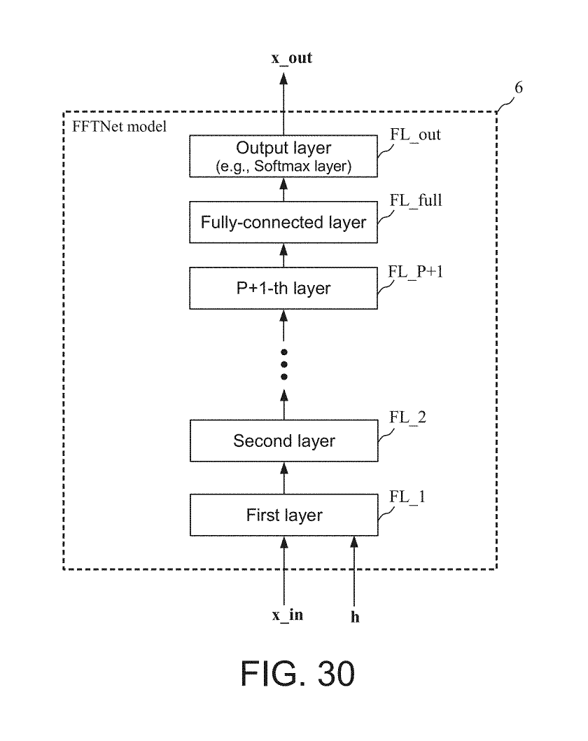

FIG. 30 is a schematic configuration diagram of a FFTNeT model 6.

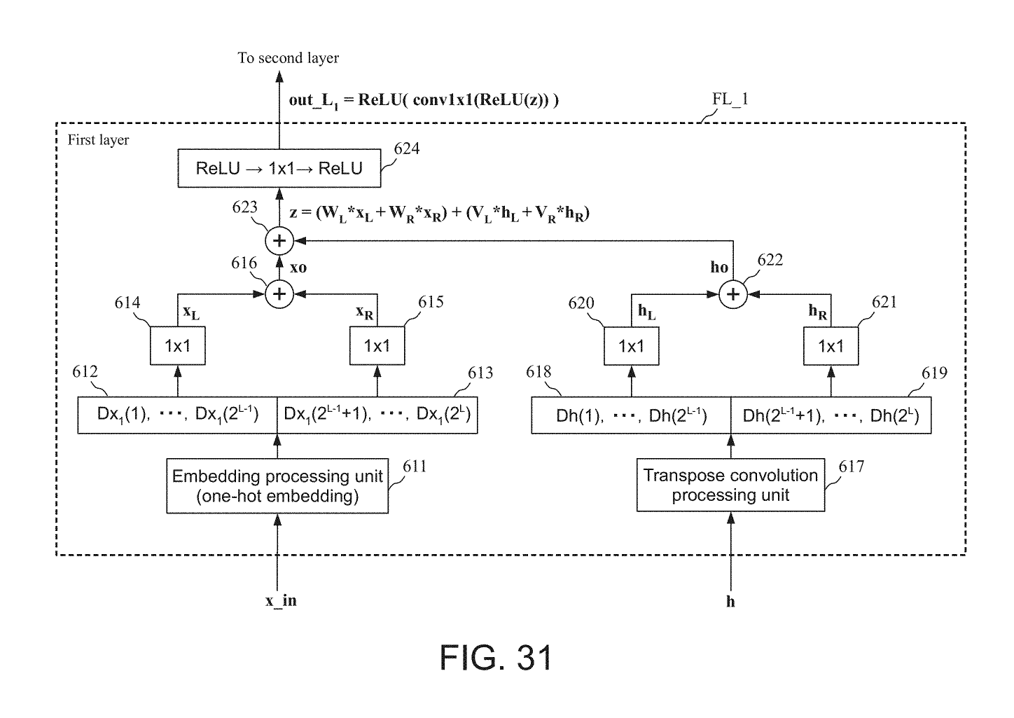

FIG. 31 is a schematic configuration diagram of a first layer of the FFTNeT model 6.

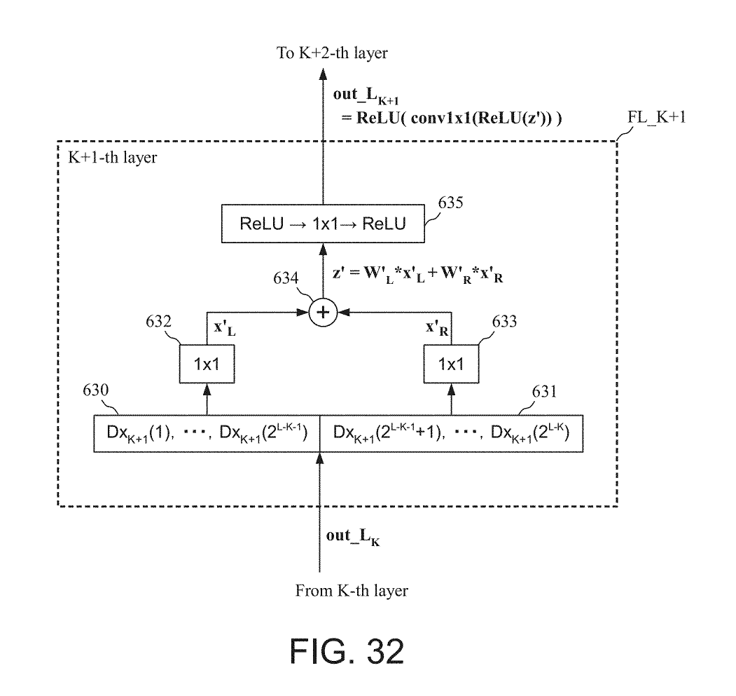

FIG. 32 is a schematic configuration diagram of a K+1-th (K is a natural number) layer of the FFTNeT model 6.

As shown in FIG. 30, the FFTNet model 6 includes a first layer FL_1, intermediate layers of a second layer FL_2 to a P+1-th layer FL_P+1 (P is a natural number), a fully-connected layer FL_full, and an output layer FL_out.

As shown in FIG. 31, the first layer FL_1 includes an embedding processing unit 611, data holding units 612 and 613, convolution units 614 and 615, a weighted-adding unit 616, a transpose convolution unit 617, data holding units 618 and 619. convolution units 620 and 621, a weighted-adding unit 622, an adding unit 623, and an activation processing unit 624.

The embedding processing unit 611 receives data x_in that is data obtained as samples that each take a discrete value within a range from 0 to 255 by μ-law compressing an audio signal, for example, and that is composed of 2^{L} samples. The embedding processing unit 611 converts each sample of the data x_in into a one-hot vector in which one bit among 0-th bit to 255-th bit of each sample is set to “1” and the other bits are set to “0”.

The data holding unit 612 holds 2^{L-1} samples that are the first sample to the 2^{L-1}-th sample among samples included in the one-hot vector obtained by the embedding processing unit 611 as Dx₁(1), Dx₂(2), . . . , Dx₁(2^{L-1}).

The data holding unit 613 holds 2^{L-1} samples that are the 2^{L-1}+1-th sample to the 2^{L}-th sample among samples included in the one-hot vector obtained by the embedding processing unit 611 as Dx₁(2^{L-1}+1), . . . , Dx₁(2^{L}).

The convolution unit 614 performs 1×1-convolution (convolution processing) on the data Dx₁(1), Dx₁(2), . . . , Dx₁(2^{L-1}) held in the data holding unit 612 to obtain convolution resultant data XL.

The convolution unit 615 performs 1×1-convolution (convolution processing) on the data Dx₁(2^{L-1}+1), . . . , Dx₁(2^{L}) held in the data holding unit 613 to obtain convolution resultant data x_{R}.

The weighted-adding unit 616 performs, on the convolution resultant data x_{L} and x_{R}, weighted-adding processing, that is, processing corresponding to the following to obtain weighted-adding processed data xo.

xo=W_{L}×x_{L}+W_{R}×x_{R}

W_{L}: weighting matrix

W_{R}: weighting matrix

The transpose convolution processing unit 617 performs transpose convolution processing (e.g., processing disclosed in Non-Patent Document 1), which is for up-sampling the auxiliary input h, on the auxiliary input h, thereby obtaining data composed 2^{L} samples (L is a natural number) derived from the auxiliary input h

The data holding unit 618 holds 2^{L-1} samples composed of the first to 2^{L-1}-th samples among 2^{L} samples obtained by the transpose convolution processing unit 617 as Dh(1), Dh(2), . . . , Dh(2^{L-1}).

The data holding unit 619 holds 2^{L-1} samples composed of the 2^{L-1}+1-th to 2^{L}-th samples among 2^{L} samples obtained by the transpose convolution processing unit 617 as Dh(2^{L-1}+1), . . . , Dh(2^{L}).

The convolution unit 620 performs 1×1-convolution (convolution processing) on the data Dh(1), Dh(2), . . . , Dh(2^{L-1}) held in the data holding unit 618 to obtain convolution resultant data h_{L}.

The convolution unit 621 performs 1×1-convolution (convolution processing) on the data Dh(2^{L-1}+1), . . . , Dh(2^{L}) held in the data holding unit 619 to obtain convolution resultant data h_{R}.

The weighted-adding unit 622 performs, on the convolution resultant data h_{L} and h_{R}, weighted-adding processing, that is, processing corresponding to the following to obtain weighted-adding processed data ho.

ho=V_{L}×h_{L}+V_{R}×h_{R}

V_{L}: weighting matrix

V_{R}: weighting matrix

The adding unit 623 performs, on the weighted-adding processed data xo and the weighted-adding processed data ho, adding processing, that is, processing corresponding to the following. thereby obtaining data z.

z=xo+ho=(W_{L}×x_{L}+W_{R}×x_{R})+(V_{L}×h_{L}+V_{R}×h_{R})

The activation processing unit 624 performs processing corresponding to the following on data z obtained by the adding unit 623, thereby obtaining output data out_L₁ of the first layer FL_1.

out_L₁=ReLU(conv1×1(ReLU(z)))

ReLU( ): a normalization linear function (ReLU: Rectified linear unit)

conv1×1( ): a function that returns an output of 1×1 convolution processing.

The output data out_L₁ of the first layer FL_1 obtained as described above is transmitted from the first layer to the second layer FL_2.

As shown in FIG. 32, the K+1-th layer FL_K+1 includes data holding units 630 and 631, convolution units 632 and 633, a weighted-adding unit 634, and an activation processing unit 635.

The data holding unit 630 holds 2^{L-K-1} samples composed of the first to 2^{L-K-1}-th samples of the output data out_Lₖ transmitted from the K-th layer as Dx_{K+1}(1), . . . , Dx_{K+1}(2^{L-K-1})

The data holding unit 631 holds 2^{L-K-1} samples composed of the 2^{L-K-1}+1-th to 2^{L-K}-th samples of the output data out_Lₖ transmitted from the K-th layer as Dx_{K+1}(2^{L-K-1}+1), . . . , Dx_{K+1}(2^{L-K}).

The convolution unit 632 performs 1×1-convolution (convolution processing) on the data Dx_{K+1}(1), . . . , Dx_{K+1}(2^{L-K-1}) held in the data holding unit 630, thereby obtaining convolution resultant data x′_{L}.

The convolution unit 633 performs 1×1-convolution (convolution processing) on the data Dx_{K+1}(2^{L-K-1}+1), . . . , Dx_{K+1}(2^{L-K}) held in the data holding unit 631, thereby obtaining convolution resultant data x′_{R}.

The weighted-adding unit 634 performs, on the convolution resultant data x′_{L} and x′_{R}, weighted-adding processing, that is. processing corresponding to the following, thereby obtaining weighted-adding processed data z′.

z′=W′_{L}×x′_{L}+W′_{R}×x′_{R}

W′_{L}: weighting matrix

W′_{R}: weighting matrix

The activation processing unit 635 performs, on the data z′ obtained by the weighted-adding unit 634, processing corresponding to the following, thereby obtaining output data out_L_{K+1} of the K+1-th layer FL_K+1.

out_L_{K+1}=ReLU(conv1×1(ReLU(z′)))

ReLU( ): Rectified linear unit function

conv1×1( ): a function that returns an output of 1×1 convolution processing.

The output data out_L_{K+1} obtained as described above is transmitted from the K+1-th layer to the K+2-th layer.

Each of the second layer to the P+1-th layer shown in FIG. 30 has the same structure as the above-described structure (the structure of the K+1-th layer).

As shown in FIG. 30, the output of the P+1-th FL_P+1 is transmitted to the fully-connected layer FL_full. Nodes (synapses) included in the fully-connected layer FL_full are connected to all the output nodes of the P+1-th layer FL_P+1. In the fully-connected layer FL_full, processing using the neural network as structured above is performed, thereby obtaining output data of the fully-connected layer FL_full. The output data of the fully-connected layer FL_full is then transmitted to the output layer.

The output layer is, for example, a softmax layer. In the output layer, an output value of each node is normalized so that the sum of output values of the nodes of the output layer becomes “1”, obtaining data x_out (e.g., data composed of 256 samples) in which an output value of each node represents a probability of posterior probability distribution.

In the audio data processing system of the present modification, the FFTNet model 6 as structured above is employed as N models of the subband learning model unit 3C and N models of the subband learned model 3B, and processing described in the first to third embodiments is performed.

As described above, the FFTNet model 6 has a very simple structure; thus, employing FFTNet model 6 in the audio data processing system of the present modification prevents the number of network parameters from increasing and allows for constructing a waveform generative model achieving high-speed processing (e.g., real-time processing).

This allows the audio data processing system of the present modification to perform the audio data processing using the raw audio generative model at high speed and obtain high-quality audio data.

Second Modification

Next, a second modification of the third embodiment will be described.

The components in the present modification that are the same as the components described in the above embodiment (including the modification) will be given the same reference numerals as those components and will not be described in detail.

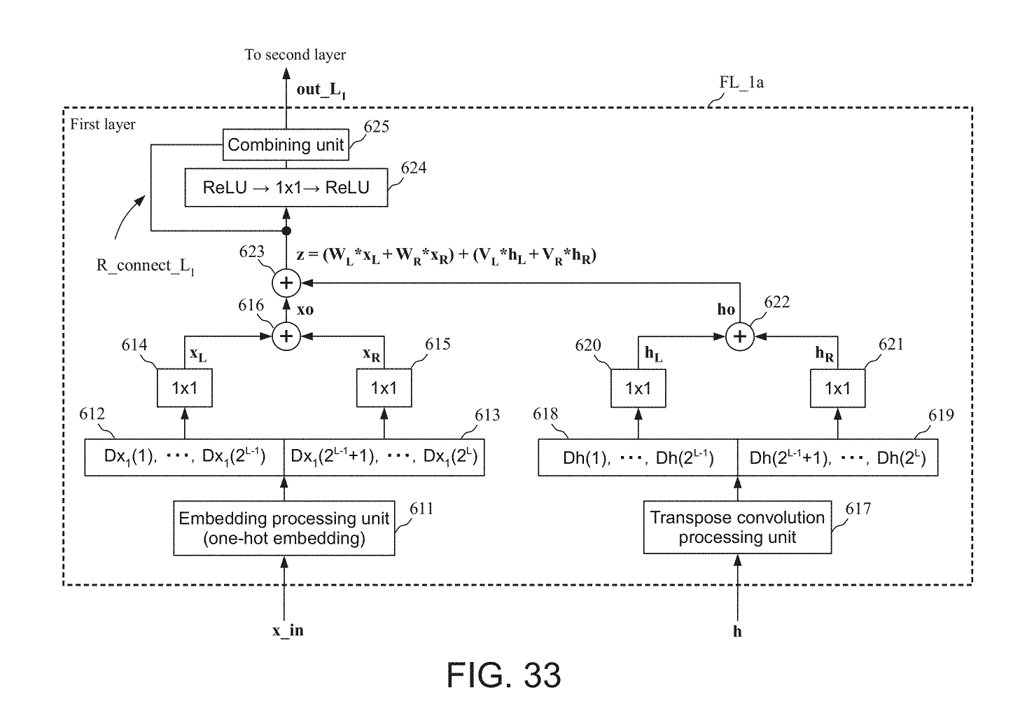

FIG. 33 is a schematic configuration diagram of a first layer FL_1a of a FFTNeT model 6 of the second modification of the third embodiment.

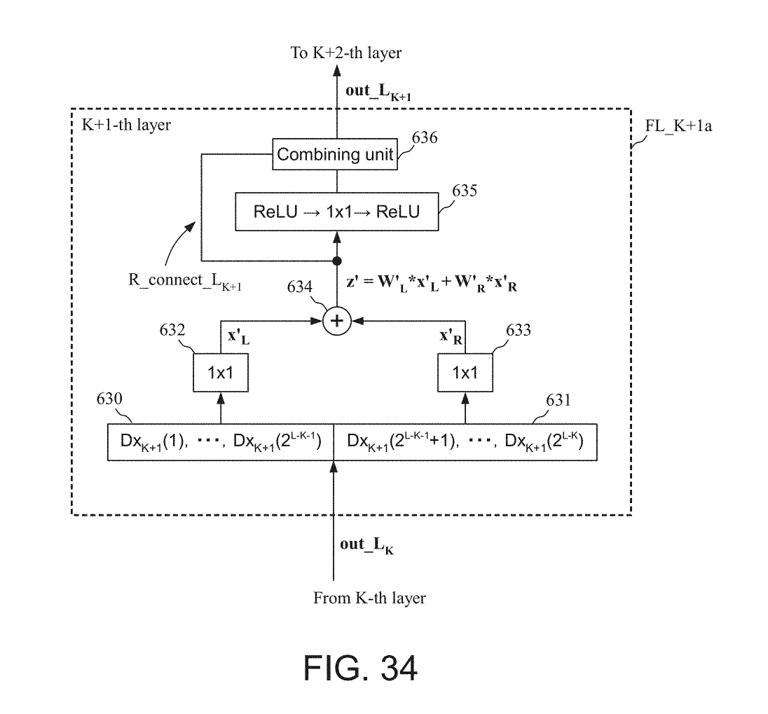

FIG. 34 is a schematic configuration diagram of a K+1-th layer FL_K+1a of the FFTNeT model 6 of the second modification of the third embodiment.

To prevent the number of network parameters from increasing and enhance model accuracy, the audio data processing system of the second modification of the third embodiment employs a residual connection.

More specifically, as shown in FIG. 33, a combining unit 625 is added in the first layer FL_1a, the combining unit 625 generates data obtained by combining both of the output of the adding unit 623 and the output of the activation processing unit 624, and the data (data including both of the output of the adding unit 623 and the output of the activation processing unit 624) is transmitted to an upper layer.

As shown in FIG. 34, a combining unit 636 is added in the K+1-th layer FL_K+1, the combining unit 636 generates data obtained by combining both of the output of the weighted-adding unit 634 and the output of the activation processing unit 635, and the data (data including both of the output of the weighted-adding unit 634 and the output of the activation processing unit 635) is transmitted to an upper layer.

Processing in this way prevents a state from occurring in which a minute change of the output of the lower layer does not propagate, thereby disturbing effective progress of learning.

Thus, employing the residual connection (e.g., the structure including a path R_connect_L1 in FIG. 33 or a path R_connect_L_{K+1} in FIG. 34) in each layer in the audio data processing system of the present modification prevents the number of network parameters from increasing and allows for enhancing the model accuracy.

This allows the audio data processing system of the present modification to perform the audio data processing using the raw audio generative model at high speed and obtain high-quality audio data.

Note that in the audio data processing system of the present modification, the residual connection may be employed only in some layers.

Third Modification

Next, a third modification of the third embodiment will be described.

The components in the present modification that are the same as the components described in the above embodiment (including modifications) will be given the same reference numerals as those components and will not be described in detail.

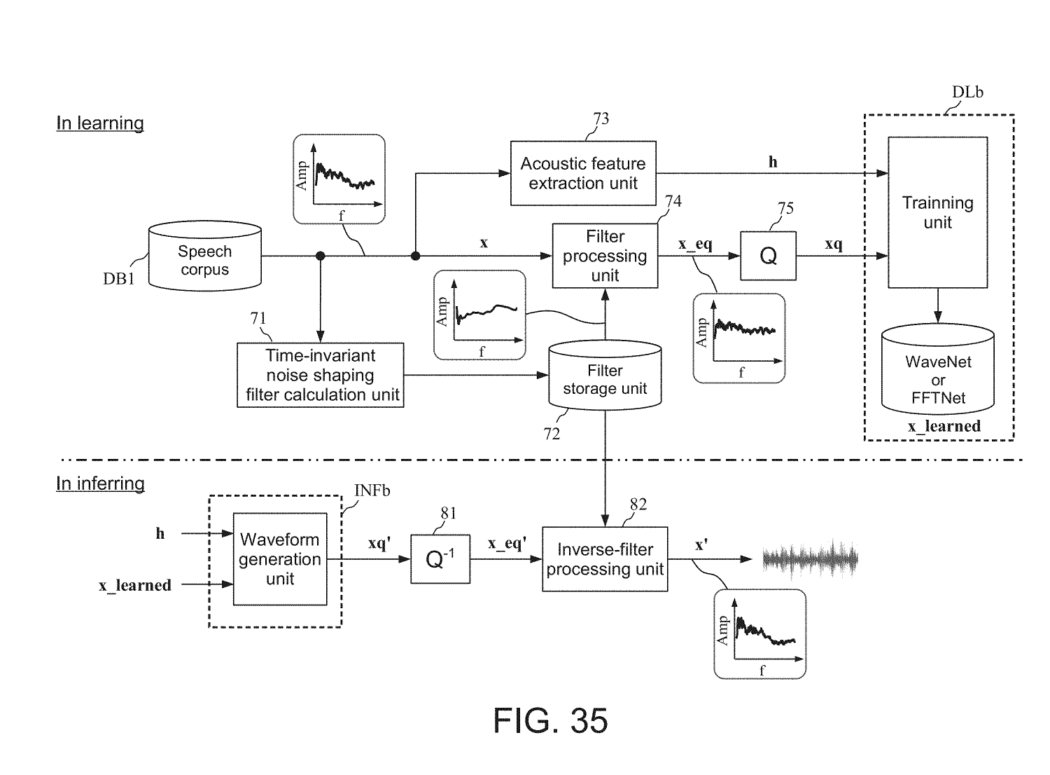

FIG. 35 is a schematic configuration diagram of an audio data processing system of the third modification of the third embodiment.

Systems using WeveNet have a problem of deteriorating frequency characteristics in high frequency regions due to noise components caused by prediction errors, resulting in deterioration of sound quality. To solve the problem, the time-invariant noise shaping method considering aural characteristics has been proposed, achieving improvement of sound quality. Thus, the method can apply to a system using FFTNet. In the third modification of the third embodiment, the FFTNet model is employed as N models of the subband learning model unit 3C and N models of the subband learned model unit 3B in the same manner as the first and second modifications of the third embodiment.

As shown in FIG. 35, the audio data processing system of the present modification includes, as a functional unit for learning processing, a speech copus DB1, a time-invariant noise shaping filter calculation unit 71, a filter storage unit 72, an acoustic feature extraction unit 73, a filter processing unit 74, a quantization unit 75, and an audio data learning apparatus DLb.

As shown in FIG. 35, the audio data processing system of the present modification includes, as a functional unit for inference processing, an audio data inference apparatus INFb, an inverse-quantization unit 81, and an inverse-filter processing unit 82.

The speech corpus DB1 is for storing audio waveform data, and is achieved with a database, for example.

The time-invariant noise shaping filter calculation unit 71 calculates an average value for a mel-generalized cepstrum from the entire of learning data stored in the speech corpus DB1, and determines (calculates) a filter with a transfer function designed as follows.

$$H ( z ) = {s}_{γ}^{- 1} ( {c}_{γ} ( 0 ) + {\sum }_{m = 1}^{Mc} β {c}_{γ} ( m ) {z}^{′ - m} ) \\ {s}_{γ}^{- 1} ( ω ) = \{ \begin{matrix}{( 1 + γω )}^{- γ} , & 0 < \vert γ \vert < 1 \\ {e}^{ω} & γ = 0 \end{matrix} \\ {z}^{′} = \frac{{z}^{- 1} - α}{1 - α {z}^{- 1}} \qquad Formula 16$$

c_{γ}(m): m-th mel-generalized cepstral coefficients

γ: a power parameter of the mel-generalized cepstrum

β: a parameter to control noise energy

Mc: the order of mel-generalized cepstrum

α: a weighting coefficient

The filter storage unit 72 stores data for the filter determined by the time-invariant noise shaping filter calculation unit 71.

The acoustic feature extraction unit 73 extracts an acoustic feature quantity h from the learning data stored in the speech corpus DB1, and transmits it to the audio data learning apparatus DLb.

The filter processing unit 74 performs filter processing on learning data x transmitted from the speech corpus DB1 based on data for filters stored in the filter storage unit 72 to obtain data x_eq after filter processing. The filter processing unit 74 then transmits the data x_eq after filter processing to the quantization unit 75.

The quantization unit 75 performs quantization processing on the data x_eq transmitted from the filter processing unit 74, and then transmits data after quantization processing, as data xq, to the audio data learning apparatus DLb.

The audio data learning apparatus DLb has the same structure as the audio data learning apparatuses DL and DLa shown in the above embodiments (including modifications), receives the acoustic feature quantity h (auxiliary input h) and data xq, and performs the same learning processing as in the above embodiments (including modifications). The audio data learning apparatus DLb obtains audio data x_learned (e.g., learned data for audio waveform data) through the above-described learning processing.

The audio data inference apparatus INFb receives the acoustic feature quantity h (auxiliary input h) and data x_learned, and performs the same inference processing as in the above embodiments (including modifications) to obtain data xq′. The audio data inference apparatus INFb then transmits the obtained data xq′ to the inverse-quantization unit 81.

The inverse-quantization unit 81 performs inverse-quantization processing on the data xq′ transmitted from the audio data inference apparatus INFb to obtain data x_eq′. The inverse-quantization unit 81 then transmits the obtained data x_eq′ to the inverse-filter processing unit 82.

The inverse-filter processing unit 82 determines (calculates) an inverse-filter having characteristics opposite to those of the filter processing unit 74 based on data for filters obtained from the filter storage unit 72. The inverse-filter processing unit 82 processing with the inverse-filter determined as described above (inverse-filter processing) on the data x_eq′ transmitted from the inverse-quantization unit 81 to obtain data x′.

The obtained data x′ in this way becomes data on which the time-invariant noise shaping process has been performed, thereby improving its sound quality.

As described above, the audio data processing system of the present modification performs learning processing and inference processing using the time-invariant noise shaping processing, thus allowing for obtaining higher quality audio data.

### Other Embodiments

The above embodiments and modifications may be freely combined to form an audio data processing system, an audio data learning apparatus, and/or an audio data inference apparatus.

Portions of the above embodiments and modifications may be combined to form an audio data processing system, an audio data learning apparatus, and/or an audio data inference apparatus.

The audio data processing system 1000, the audio data learning apparatus DL, and the audio data inference apparatus INF of the above embodiments may be each achieved using a plurality of apparatuses.

In the audio data learning apparatus DL and the audio data inference apparatus INF of the above embodiments, all or part of the functional units that can be shared may be commonly shared.

In the above embodiments, a case in which after performing frequency shift processing in the subband dividing unit 1 of the audio data learning apparatus DL, the band limiting filter processing is performed has been described. However, the present invention should not be limited to this case. For example, after performing band limiting processing in the subband dividing unit 1 of the audio data learning apparatus DL, frequency shift processing may be performed. In this case, the first band limiting filter processing unit 121 to the N-th band limiting filter processing unit 12N may perform processing with a filter having filter characteristics shown in FIG. 12(b), for example (filter bank configuration).

The audio data learning apparatus DL of the above embodiment may set the auxiliary input h to data for a context label, and learning processing for a TTS (Text to Speech) system may be performed by inputting audio data (audio signal) corresponding to the context label into the audio data learning apparatus DL and then performing learning processing.

Setting the auxiliary input h to data for a context label allows for estimating (outputting) audio data (audio signal) corresponding to the context label.

In the above, data for acoustic feature quantity may be set to the auxiliary input h instead of data for the context label.

The audio data learning apparatus DL of the above embodiment may set the auxiliary input to data for determining a speaker, and perform learning processing by inputting the audio data (audio signal) of the speaker into the audio data learning apparatus DL.

Setting the auxiliary input h to the data for determining the speaker allows for estimating (outputting) audio data (audio signal) corresponding to the speaker (audio that causes feelings as if the speaker is talking).

The audio data learning apparatus DL of the above embodiment may set the auxiliary input to data for music (e.g., data for determining an instrument), and perform learning processing by inputting the audio data (audio signal) of the data for music into the audio data learning apparatus DL.

Setting the auxiliary input h to the data for music allows for estimating (outputting) audio data (audio signal) corresponding to the data for music (e.g., sound signal of a piano when the data for music is set to data for “piano”).

Each block of the audio data processing system 1000, the audio data learning apparatus DL, and/or the audio data inference apparatus INF described in the above embodiment may be formed using a single chip with a semiconductor device, such as an LSI (large-scale integration) device, or some or all of the blocks of the state estimation apparatus may be formed using a single chip.

Although LSI is used as the semiconductor device technology, the technology may be an IC (integrated circuit), a system LSI, a super LSI. or an ultra LSI depending on the degree of integration of the circuit.

The circuit integration technology employed should not be limited to LSI, but the circuit integration may be achieved using a dedicated circuit or a general-purpose processor. A field programmable gate array (FPGA), which is an LSI circuit programmable after manufactured, or a reconfigurable processor, which is an LSI circuit in which internal circuit cells are reconfigurable or more specifically the internal circuit cells can be reconnected or reset, may be used.

All or part of the processes performed by the functional blocks described in the above embodiments may be implemented using programs. All or part of the processes performed by the functional blocks described in the above embodiments is implemented by a central processing unit (CPU) included in a computer. The programs for these processes may be stored in a storage device, such as a hard disk or a ROM. and may be executed from the ROM or be read into a RAM and then executed.

The processes described in the above embodiments may be implemented using either hardware or software (which may be combined together with operating system (OS), middleware, or predetermined library), or may be implemented using both software and hardware.

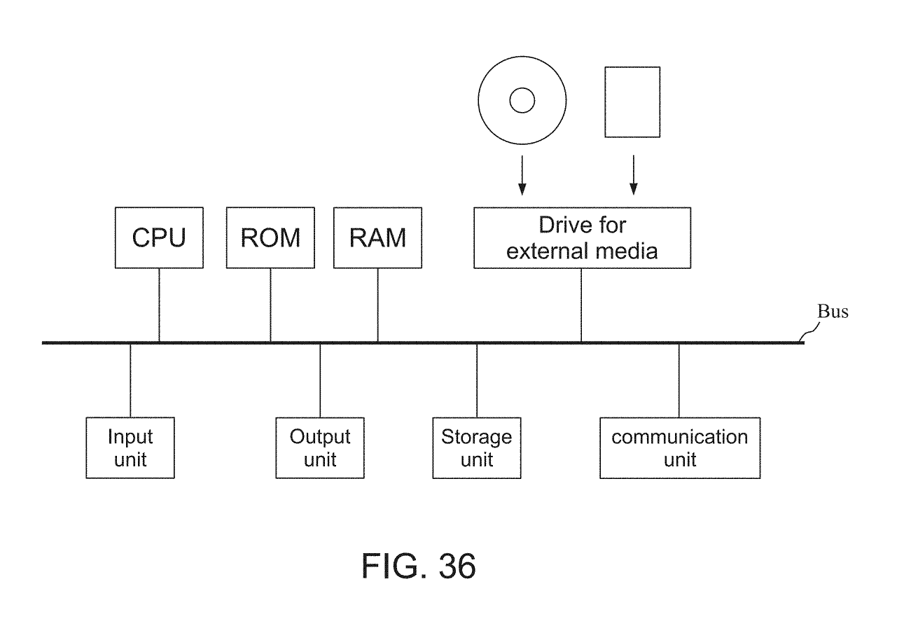

For example, when functional units of the above embodiments are achieved by using software, the hardware structure (the hardware structure including CPU, ROM, RAM, an input unit, an output unit, a communication unit, a storage unit (e.g., a storage unit achieved using an HDD, a SSD or the like), and/or a drive unit for external media, each of which is connected to a bus) shown in FIG. 36 may be employed to achieve the functional units by using software.

In a case where each functional unit of the embodiment is implemented by software, the software may be achieved by using a single computer having the hardware configuration shown in FIG. 36, or may be achieved by distributed processing using a plurality of computers.

The processes described in the above embodiments may not be performed in the order specified in the above embodiments. The order in which the processes are performed may be changed without departing from the scope and the spirit of the invention.

The present invention may also include a computer program enabling a computer to implement the method described in the above embodiments and a computer readable recording medium on which such a program is recorded. Examples of the computer readable recording medium include a flexible disk, a hard disk, a CD-ROM, an MO, a DVD, a DVD-ROM, a DVD-RAM, a large capacity DVD, a next-generation DVD, and a semiconductor memory.

The computer program should not be limited to a program recorded on the recording medium, but may be a program transmitted with an electric communication line, a radio or cable communication line, or a network such as the Internet.

The specific structures described in the above embodiments are mere examples of the present invention, and may be changed and modified variously without departing from the scope and the spirit of the invention.

### APPENDIX

The present invention may also be expressed in the following forms.

A first aspect of the present invention provides an audio data learning method including a subband dividing step, a down-sampling processing step, and a subband learning model step.

The subband dividing step obtains a subband signal by performing processing to limit frequency bands with respect to audio data.

The down-sampling processing step performs down-sampling processing on the subband signal by thinning out sample data obtained by sampling a signal value of the subband signal with a sampling frequency.

The subband learning step performs learning of a raw audio generative model using an auxiliary data and the subband data obtained by the down-sampling step.

The audio data learning method divides audio data (e.g., full band waveform data) into subband signals and performs model-learning (optimization) using the divided subband signals by the subband learning model step. The subband learning model step performs model-learning (optimization) in parallel with subband signals using N models (the first subband learning model to the N-th subband learning model). In other words, the audio data learning method allows for performing learning (optimization) of the raw audio generative model in parallel.

Note that “audio data” is a concept including audio data, music data, data for an audio signal, or the like.

In the subband learning model step, the auxiliary input data may be omitted.

Note that “raw audio generative model” is a model that receives data for signal waveform of an audio signal as data for learning, and obtains data for the current time (e.g., x(t)) from a plurality of pieces of data for the signal waveform in the past (e.g., assuming that the current time is t, all the sample data from time 0 to time t−1 (x(0) to x(t−1))).

Also, in the first aspect of the invention, assuming that a sampling frequency for the audio data is fs, frequency bandwidth for all frequencies for the audio data is fs/2, the subband dividing step may perform band limiting filter processing on the audio data using a band limiting filter having filter characteristics in which assuming a target frequency bandwidth Δf satisfies Δf=fs/(2N), where N is a natural number, a width of a frequency band whose gain is −1 dB or more is less than or equal to Δf/2, thereby obtaining the subband signal.

This enables the audio data learning method to perform model-learning using a subband signal forcibly colorized (characteristics are not flat), that is, a signal easy to predict, thus allowing for performing model-learning more appropriately than performing model-learning using the full band waveform data as in the conventional technique.

A second aspect of the invention provides the method of the first aspect of the invention in which the subband dividing step obtains N subband signals (N is a natural number) as a first subband signal x_sub₁, . . . , a k-th subband signal x_subₖ (k is a natural number satisfying 1≤k≤N), . . . , an N-th subband signal x_sub_{N}.

The down-sampling processing step obtains signals obtained by performing down-sampling on the filter subband signal x_sub₁, . . . , the k-th subband signal x_subₖ (k is a natural number satisfying 1≤k≤N) as a first down-sampling subband signal x_d₁, . . . , a k-th down-sampling subband signal x_dₖ, . . . , an N-th down-sampling subband signal x_d_{N}, respectively.

The subband learning model step performs processing using a first subband learning model to an N-th subband learning model, which are N subband learning models.

The k-th subband learning model (k is a natural number satisfying 1≤k≤N) receives the auxiliary input data and the k-th down-sampling subband signal x_dₖ.

At least one of the N subband learning models is a subband learning model for phase compensation, assuming that an m-th subband learning model (m is a natural number satisfying 1≤m≤N) is a subband learning model for phase compensation, and a natural number n (n is a natural number satisfying 1≤n≤N and n is not equal to m) differs from a natural number m, the m-th subband learning model receives (1) the auxiliary input data, (2) an m-th down-sampling subband signal x_dₘ. and (3) an n-th down-sampling subband signal x_dₙ.

In the audio data learning method, at least one of the N subband models is a subband learning model for phase compensation, it receives a down-sampling subband signal for another subband learning model and performs learning processing, thus achieving appropriate phase compensation. In other words, the audio data learning method achieves appropriate phase compensation due to the structure in which multiple bands are to be inputted, thereby allowing an audio data processing system using the audio data learning method to obtain higher-quality audio data.

A third aspect of the invention provides the method of the second aspect of the invention in which the subband learning model is a model achieving a neural network composed of a plurality of layers.

A first layer, which is an input layer of the subband learning model, receives the auxiliary input data and the k-th down-sampling subband signal x_dₖ, the first layer comprising.

The first layer, which is an input layer of the subband learning model, includes an auxiliary input data conversion unit, a subband signal conversion unit, a 1×1 convolution processing unit, a weighted-adding unit, and an activation processing unit.

The auxiliary input data conversation unit converts the auxiliary input data into two pairs of data h1_{L} and h1_{R} each composed of 2^{L-1} samples (L is a natural number).

The subband signal conversation unit converts the k-th down-sampling subband signal x_dₖ into two pairs of data x1_{L} and x1_{R} each composed of 2^{L-1} samples.

The 1×1 convolution processing unit performs 1×1 convolution processing on the data h1_{L}, h1_{R}, x1_{L}, and x1_{R} to obtain data after processing as data h_{L}, h_{R}, x_{L}, and x_{R}, respectively.

The weighted-adding unit performs, on the data h_{L}, h_{R}, x_{L}, and x_{R}, processing corresponding to

z=(W_{L}×x_{L}+W_{R}×x_{R})+(V_{L}×h_{L}+V_{R}×h_{R})

W_{L}: weighting matrix

W_{R}: weighting matrix

V_{L}: weighting matrix

V_{R}: weighting matrix,

thereby obtaining data z.

The activation processing unit performs, on the data z, processing corresponding to

out_L₁=ReLU(conv1×1(ReLU(z)))

ReLU( ): a normalization linear function (ReLU: Rectified linear unit)

conv1×1( ): a function that returns an output of 1×1 convolution processing,

thereby output data out_L₁ of the first layer.

A K+1-th layer (K is a natural number) of the subband learning model receives output data out_Lₖ transmitted from a K-th layer.

The K+1-th layer (K is a natural number) of the subband learning model includes a data conversion unit, a 1×1 convolution processing unit, a weighted-adding unit, and a K+1-th layer activation processing unit.

The data conversion unit converts output data out_Lₖ transmitted from the K-th layer into two pairs of data x′1L and x′1R each composed of 2^{L-K-1} samples (L is a natural number).

The 1×1 convolution processing unit performs 1×1 convolution processing on the data x′1_{L} and x′1_{R} to obtain data after processing as data x′_{L} and x′_{R}.

The weighted-adding unit performs, on the data x′L and x′_{R}, processing corresponding to

z′=W′_{L}×x′_{L}+W′_{R}×x′_{R}

W′_{L}: weighting matrix

W′_{R}: weighting matrix,

thereby obtaining data z′.

The K+1-th layer activation processing unit performs, on the data z′, processing corresponding to

out_L_{K+1}=ReLU(conv1×1(ReLU(z′)))

ReLU( ): a normalization linear function (ReLU: Rectified linear unit)

conv1×1( ): a function that returns an output of 1×1 convolution processing,

thereby obtaining output data out_L_{K+1} of the K+1-th layer.

This allows the audio data learning method to perform processing (learning processing) using the FFTNet model.

A fourth aspect of the invention provides the method of the third aspect of the invention in which a first layer of the subband learning model generates data including the data z transmitted from the weighted-adding unit and the data out_L₁ transmitted from the activation processing unit, and outputs the generated data as output data of the first layer.

This allows the audio data learning method to employ the residual connection in the first layer of the subband learning model, thus preventing the number of network parameters from increasing and improving the model accuracy.

This allows an audio data processing system using the audio data learning method to perform audio data processing using the raw audio generative model at high speed and obtain high quality audio data.

A fifth aspect of the invention provides the method of the third embodiment aspect of the invention in which a K+1-th layer of the subband learning model generates data including the data z′ transmitted from the weighted-adding unit and the data out_L_{K+1} transmitted from the K+1-th layer activation processing unit, and outputs the generated data as output data of the K+1-th layer.

This allows the audio data learning method to employ the residual connection in the K+1-th layer of the subband learning model, thus preventing the number of network parameters from increasing and improving the model accuracy.

This allows an audio data processing system using the audio data learning method to perform audio data processing using the raw audio generative model at high speed and obtain high quality audio data.

A sixth aspect of the invention provides the method of the first aspect of the invention in which data obtained by performing, on audio data, filter processing obtained based on a time-invariant noise shaping method is used as data for learning in learning processing.

This allows the audio data learning method to perform learning processing using time-invariant noise shaping processing, thus allowing for obtaining high quality audio data.

A seventh aspect of the invention provides the method of the first aspect of the invention in which the subband dividing step obtains the subband signal by performing band limiting filter processing on the audio data using a band limiting filter whose transfer function is as follows:

(1) If −π/(N−1)≤ω≤π/(N−1) is satisfied, then

$$H ( ω ) = \sqrt{cos ( \frac{N - 1}{2} ω )} \qquad Formula 17$$

(2) If ω<−π/(N−1) or ω>π/(N−1) is satisfied, then

H(ω)=0.

This enables the audio data learning method to perform model-learning using a subband signal forcibly colorized (subband signal obtained through band limiting processing having square root cosine characteristics), that is, a signal easy to predict, thus allowing for performing model-learning more appropriately than performing model-learning using the full band waveform data as in the conventional technique.

A eighth aspect of the present invention provides an audio data inference method for performing inference processing using N (N is a natural number) learned models obtained by learning a raw audio generative model using an auxiliary input and a subband signal obtained by performing frequency limiting processing on audio data. The audio data inference method includes a subband signal outputting step, a subband learned model step, an up-sampling processing step, and a subband synthesis step.

The subband signal outputting step performs processing using the N learned models when at least one of the auxiliary input data and the subband signal is inputted, and outputs N subband signals after inference processing.

The up-sampling processing step performs up-sampling processing on the N subband signals after inference processing, thereby obtaining N subband signals after up-sampling processing.

The subband synthesis step performs frequency band limiting processing on the N subband signals after up-sampling processing, and then performs synthesis processing to obtain output data.

In an audio data inference method, the subband signal outputting step that receives at least one of the auxiliary input and subband signals achieving inference processing in parallel. In other words, using N subband learned models (the first subband learned model to the N-th subband learned model) in the subband signal outputting step allows for inference processing in parallel using subband signals. The audio data inference method, after performing up-sampling on resultant data of inference with the N subband learned models (the first subband learned model to the N-th subband learned model), performs subband synthesis processing, thereby obtaining resultant data of inference processing for full band audio data.

In other words, in the audio data inference method, inference processing for the raw audio generative model is achieved using parallel processing. As a result, with the audio data inference method, the inference processing is performed much faster than the inference processing with the raw audio generative model using the full band waveform data as in the conventional technique.

Thus, the audio data inference method allows audio data processing using the raw audio generative model to be performed at high speed.

Also, in the eighth aspect of the invention, assuming that a sampling frequency for the audio data is fs, a frequency bandwidth for all frequencies for the audio data is fs/2, the subband synthesis step may perform band limiting filter processing on the N subband signals after up-sampling processing using a band limiting filter having filter characteristics in which assuming target frequency bandwidth is Δf satisfying Δf=fs/(2N) (N is a natural number), a width of a frequency band whose gain is −1 dB or more is less than or equal to Δf/2, and then performs synthesis processing to obtain the output data.

This enables the audio data inference method to adjust filter characteristics of the above band limiting filter depending on filter characteristics of band limiting filters used for forcibly colorizing in learning. In the audio data inference method, band limiting filter processing with the filter characteristics can be performed for the N subband signals after up-sampling processing. Thus, synthesizing the subband signals after band limiting processing allows the energy of the output data to be equal to that of its original signal (signal to be originally expected). This allows the audio data inference method to obtain high quality audio data (output data).

Note that a gain adjustment step of adjusting a level of data (signal) obtained by the audio data inference method may be included in the audio data inference method.

A ninth aspect of the invention provides the method of the eighth aspect of the invention in which assuming that the N subband signals are a first subband signal xa₁, . . . , a k-th subband signal xaₖ (k is a natural number satisfying 1≤k≤N), . . . , an N-th subband signal xa_{N}, the subband signal outputting step performs processing using a first subband learned model to an N-th subband learned model, which are the N learned model.

The k-th subband learned model (k is a natural satisfying 1≤k≤N) receives the auxiliary input data and the k-th subband signal xaₖ.

At least one of the N subband learned models is a subband learned model for phase compensation. Assuming that an m-th subband learned model (m is a natural number satisfying 1≤m≤N) is a subband learned model for phase compensation, and a natural number n (n is a natural number satisfying 1≤n≤N and n is not equal to m) differs from a natural number m, the m-th subband learned model receives (1) the auxiliary input data, (2) an m-th subband signal xaₘ, and (3) an n-th subband signal xaₙ.

In the audio data inference method, at least one of the N subband learned models is a subband learned model for phase compensation. The audio data inference model receives a subband signal for another subband learned model, and then performs inference processing, thereby achieving appropriate phase compensation. In other words, the audio data inference method achieves appropriate phase compensation due to the structure in which multiple bands are to be inputted, thus allowing for obtaining much higher quality audio data.

A tenth aspect of the invention provides the method of the ninth aspect of the invention in which the subband learned model is a model achieved using a neural network composed of a plurality of layers.

The first layer, which is an input layer of the subband learned model, receives the auxiliary input data and the k-th subband signal xaₖ. The first layer includes an auxiliary input data conversion unit, a subband signal conversion unit, a 1×1 convolution unit, a weighted-adding unit, and an activation unit.

The auxiliary input data conversation unit converts the auxiliary input data into two pairs of data h1_{L} and h1_{R} each composed of 2^{L-1} samples (L is a natural number).

The subband signal conversation unit converts the k-th subband signal xaₖ into two pairs of data x1_{L} and x1_{R} each composed of 2^{L-1} samples.

The 1×1 convolution processing unit performs 1×1 convolution processing on the data h1_{L}, h1_{R}, x1_{L}, and x1_{R} to obtain data after processing as data h_{L}, h_{R}, x_{L}, and x_{R}, respectively.

The weighted-adding unit performs, on the data h_{L}, h_{R}, x_{L}, and x_{R}, processing corresponding to

z=(W_{L}×x_{L}+W_{R}×x_{R})+(V_{L}×h_{L}+V_{R}×h_{R})

W_{L}: weighting matrix

W_{R}: weighting matrix

V_{L}: weighting matrix

V_{R}: weighting matrix,

thereby obtaining data z.

The activation processing unit performs, on the data z, processing corresponding to

out_L₁=ReLU(conv1×1(ReLU(z)))

ReLU( ): a normalization linear function (ReLU: Rectified linear unit)

conv1×1( ): a function that returns an output of 1×1 convolution processing,

thereby obtaining output data out_L₁ of the first layer.

The K+1-th layer (K is a natural number) of the subband learned model receives output data out_Lₖ transmitted from a K-th layer. The K+1-th layer includes a data conversion unit, a 1×1 convolution processing unit, a weighted-adding unit, and a K+1-th layer activation processing unit.

The data conversion unit converts output data out_Lₖ transmitted from the K-th layer into two pairs of data x′1_{L} and x′1_{R} each composed of 2^{L-K-1} samples (L is a natural number).

The 1×1 convolution processing unit performs 1×1 convolution processing on the data x′1_{L} and x′1_{R} to obtain data after processing as data x′_{L} and x′_{R}.

The weighted-adding unit performs, on the data x′_{L} and x′_{R}, processing corresponding to

z′=W′_{L}×x′_{L}+W′_{R}×x′_{R}

W′_{L}: weighting matrix

W′_{R}: weighting matrix,

thereby obtaining data z′.

The K+1-th layer activation processing unit performs, on the data z′, processing corresponding to

out_L_{K+1}=ReLU(conv1×1(ReLU(z′)))

ReLU( ): a normalization linear function (ReLU: Rectified linear unit)

conv1×1( ): a function that returns an output of 1×1 convolution processing,

thereby obtaining output data out_L_{K+1} of the K+1-th layer.

This allows the audio data inference method to perform processing (inference processing) using the FFTNet model.

An eleventh aspect of the invention provides the method of the tenth aspect of the invention in which a first layer of the subband learned model generates data including the data z transmitted from the weighted-adding unit and the data out_L₁ transmitted from the activation processing unit, and outputs the generated data as output data of the first layer.

This allows the audio data inference method to employ the residual connection in the first layer of the subband learned model, thus preventing the number of network parameters from increasing and improving the model accuracy.

This allows an audio data processing system using the audio data inference method to perform audio data processing using the raw audio generative model at high speed and obtain high quality audio data.

A twelfth aspect of the invention provides the method of the tenth aspect of the invention in which the K+1-th layer of the subband learned model generates data including the data z′ transmitted from the weighted-adding unit and the data out_L_{K+1} transmitted from the K+1-th layer activation processing unit, and outputs the generated data as output data of the K+1-th layer.

This allows the audio data inference method to employ the residual connection in the K+1-th layer of the subband learned model, thus preventing the number of network parameters from increasing and improving the model accuracy.

This allows an audio data processing system using the audio data inference method to perform audio data processing using the raw audio generative model at high speed and obtain high quality audio data.

A thirteenth aspect of the invention provides the method of the eighth aspect of the invention in which when data obtained by performing filter processing on audio data using a time-invariant noise shaping method is used as data for learning in learning processing, output data is obtained, in inference processing, by performing processing using a filter having filter characteristics opposed to those of the filter processing.

This allows the audio data inference method to perform inference processing using time-invariant noise shaping processing, thus allowing for obtaining high quality audio data.

A fourteenth aspect of the invention provides the method of the eighth aspect of the invention in which the subband synthesis step obtains the output data by performing the synthesis processing after performing band limiting processing on the N subband signals after up-sampling processing using a band limiting filter whose transfer function is as follows:

(1) If −π/(N−1)≤ω≤π/(N−1) is satisfied, then

$$H ( ω ) = \sqrt{cos ( \frac{N - 1}{2} ω )} \qquad Formula 18$$

(2) If ω<−π(N−1) or ω>π/(N−1) is satisfied, then

H(ω)=0.

This enables the audio data inference method to set the filter characteristics of the above band limiting filter to the filter characteristics of the square root cosine characteristics depending on filter characteristics (square root characteristics) of band limiting filters used for forcibly colorizing in learning. The audio data inference method performs band limiting filter processing on the N subband signals after up-sampling processing using the above filter characteristics. Thus, synthesizing the subband signals after band limiting processing allows the energy of the output data to be equal to that of its original signal (signal to be originally expected). This allows the audio data inference method to obtain high quality audio data (output data).

A fifteenth aspect of the invention provides a non-transitory computer readable storage media storing a program enabling a computer to implement the audio data learning method of the first aspect of the invention.

This achieves a non-transitory computer readable storage media storing a program enabling a computer to implement the audio data learning method having the same advantageous effects as the method of the first aspect of the present invention.

A sixteenth aspect of the invention provides a non-transitory computer readable storage media storing a program enabling a computer to implement the audio data inference method of the eighth aspect of the invention.

This achieves a non-transitory computer readable storage media storing a program enabling a computer to implement the audio data inference method having the same advantageous effects as the method of the eighth aspect of the present invention.

What is claimed is:

1. An audio data learning method comprising:
a subband dividing step of obtaining a subband signal by performing processing to limit frequency bands with respect to audio data;
a down-sampling processing step of performing down-sampling processing on the subband signal by thinning out sample data obtained by sampling a signal value of the subband signal with a sampling frequency; and
a subband learning step of performing learning of a raw audio generative model using an auxiliary data and the subband data obtained by the down-sampling step.

2. The audio data learning method according to claim 1, wherein
the subband dividing step obtains N subband signals (N is a natural number) as a first subband signal x_sub₁, . . . , a k-th subband signal x_subₖ (k is a natural number satisfying 1≤k≤N), . . . , an N-th subband signal x_sub_{N},
the down-sampling processing step obtains signals obtained by performing down-sampling on the filter subband signal x_sub₁, . . . , the k-th subband signal x_subₖ (k is a natural number satisfying 1≤k≤N) as a first down-sampling subband signal x_d₁, . . . , a k-th down-sampling subband signal x_dₖ, . . . , an N-th down-sampling subband signal x_d_{N}, respectively,
the subband learning model step performs processing using a first subband learning model to an N-th subband learning model, which are N subband learning models,
a k-th subband learning model (k is a natural number satisfying 1≤k≤N) receives the auxiliary input data and the k-th down-sampling subband signal x_dₖ, and
at least one of the N subband learning models is a subband learning model for phase compensation, assuming that an m-th subband learning model (m is a natural number satisfying 1≤m≤N) is a subband learning model for phase compensation, and a natural number n (n is a natural number satisfying 1≤n≤N and n is not equal to m) differs from a natural number m, the m-th subband learning model receives (1) the auxiliary input data, (2) an m-th down-sampling subband signal x_dₘ, and (3) an n-th down-sampling subband signal x_dₙ.

3. The audio data learning method according to claim 2,
wherein the subband learning model is a model achieving a neural network composed of a plurality of layers,
wherein a first layer, which is an input layer of the subband learning model, receives the auxiliary input data and the k-th down-sampling subband signal x_dₖ, the first layer comprising:
an auxiliary input data conversation unit configured to convert the auxiliary input data into two pairs of data h1_{L} and h1_{R} each composed of 2^{L-1} samples (L is a natural number);
a subband signal conversation unit configured to convert the k-th down-sampling subband signal x_dₖ into two pairs of data x1_{L} and x1_{R} each composed of 2^{L-1} samples;
a 1×1 convolution processing unit configured to perform 1×1 convolution processing on the data h1_{L}, h1_{R}, x1_{L}, and x1_{R} to obtain data after processing as data h_{L}, h_{R}, x_{L}, and x_{R}, respectively;
a weighted-adding unit configured to perform, on the data h_{L}, h_{R}, x_{L}, and x_{R}, processing corresponding to
z=(W_{L}×x_{L}+W_{R}×x_{R})+(V_{L}×h_{L}+V_{R}×h_{R})
W_{L}: weighting matrix
W_{R}: weighting matrix
V_{L}: weighting matrix
V_{R}: weighting matrix,
thereby obtaining data z; and
an activation processing unit configured to perform, on the data z, processing corresponding to
out_L₁=ReLU(conv1×1(ReLU(z)))
ReLU( ): a normalization linear function (ReLU: Rectified linear unit)
conv1×1( ): a function that returns an output of 1×1 convolution processing,
thereby output data out_L₁ of the first layer, and
wherein a K+1-th layer (K is a natural number) of the subband learning model receives output data out_Lₖ transmitted from a K-th layer, the K+1-th layer comprising:
a data conversion unit configured to convert output data out_Lₖ transmitted from the K-th layer into two pairs of data x′1_{L} and x′1_{R} each composed of 2^{L-K-1} samples (L is a natural number);
a 1×1 convolution processing unit configured to perform 1×1 convolution processing on the data x′1_{L} and x′1_{R} to obtain data after processing as data x′_{L} and x′_{R};
a weighted-adding unit configured to perform, on the data x′_{L} and x′_{R}, processing corresponding to
z′=W′_{L}×X′_{L}+W′_{R}×X′_{R}
W′_{L}: weighting matrix
W′_{R}: weighting matrix,
thereby obtaining data z′; and
a K+1-th layer activation processing unit configured to perform, on the data z′, processing corresponding to
out_L_{K+1}=ReLU(conv1×1(ReLU(z′)))
ReLU( ): a normalization linear function (ReLU: Rectified linear unit)
conv1×1( ): a function that returns an output of 1×1 convolution processing,
thereby obtaining output data out_L_{K+1} of the K+1-th layer.

4. The audio data learning method according to claim 3, wherein
a first layer of the subband learning model generates data including the data z transmitted from the weighted-adding unit and the data out_L₁ transmitted from the activation processing unit, and outputs the generated data as output data of the first layer.

5. The audio data learning method according to claim 3, wherein
a K+1-th layer of the subband learning model generates data including the data z′ transmitted from the weighted-adding unit and the data out_L_{K+1} transmitted from the K+1-th layer activation processing unit, and outputs the generated data as output data of the K+1-th layer.

6. The audio data learning method according to claim 1, wherein data obtained by performing, on audio data, filter processing obtained based on a time-invariant noise shaping method is used as data for learning in learning processing.

7. The audio data learning method according to claim 1, wherein
the subband dividing step obtains the subband signal by performing band limiting filter processing on the audio data using a band limiting filter whose transfer function is as follows:
(1) If −π/(N−1)≤ω≤π/(N−1) is satisfied, then
$$H ( ω ) = \sqrt{cos ( \frac{N - 1}{2} ω )}$$
(2) If ω<−π/(N−1) or ω>π/(N−1) is satisfied, then
H(ω)=0.

8. An audio data inference method for performing inference processing using N (N is a natural number) learned models obtained by learning a raw audio generative model using an auxiliary input and a subband signal obtained by performing frequency limiting processing on audio data, the audio data inference method comprising:
a subband signal outputting step of performing processing using the N learned models when at least one of the auxiliary input data and the subband signal is inputted, and outputting N subband signals after inference processing;
an up-sampling processing step of performing up-sampling processing on the N subband signals after inference processing, thereby obtaining N subband signals after up-sampling processing; and
a subband synthesis step of performing frequency band limiting processing on the N subband signals after up-sampling processing, and then performing synthesis processing to obtain output data.

9. The audio data inference method according to claim 8,
wherein assuming that the N subband signals are a first subband signal xa₁, . . . , a k-th subband signal xaₖ (k is a natural number satisfying 1≤k≤N), . . . , an N-th subband signal xa_{N}, the subband signal outputting step performs processing using a first subband learned model to an N-th subband learned model, which are the N learned model,
wherein a k-th subband learned model (k is a natural satisfying 1≤k≤N) receives the auxiliary input data and the k-th subband signal xaₖ, and
wherein at least one of the N subband learned models is a subband learned model for phase compensation, assuming that an m-th subband learned model (m is a natural number satisfying 1≤m≤N) is a subband learned model for phase compensation, and a natural number n (n is a natural number satisfying 1≤n≤N and n is not equal to m) differs from a natural number m, the m-th subband learned model receives (1) the auxiliary input data, (2) an m-th subband signal xaₘ, and (3) an n-th subband signal xaₙ.

10. The audio data inference method according to claim 9,
wherein the subband learned model is a model achieved using a neural network composed of a plurality of layers,
wherein a first layer, which is an input layer of the subband learned model, receives the auxiliary input data and the k-th subband signal xaₖ, the first layer comprising:
an auxiliary input data conversation unit configured to convert the auxiliary input data into two pairs of data h1_{L} and h1_{R} each composed of 2^{L-1} samples (L is a natural number);
a subband signal conversation unit configured to convert the k-th subband signal xaₖ into two pairs of data x1_{L} and x1_{R} each composed of 2^{L-1} samples;
a 1×1 convolution processing unit configured to perform 1×1 convolution processing on the data h1_{L}, h1_{R}, x1_{L}, and x1_{R} to obtain data after processing as data h_{L}, h_{R}, x_{L}, and x_{R}, respectively;
a weighted-adding unit configured to perform, on the data h_{L}, h_{R}, x_{L}, and x_{R}, processing corresponding to
z=(W_{L}×x_{L}+W_{R}×x_{R})+(V_{L}×h_{L}+V_{R}×h_{R})
W_{L}: weighting matrix
W_{R}: weighting matrix
V_{L}: weighting matrix
V_{R}: weighting matrix,
thereby obtaining data z, and
an activation processing unit configured to perform, on the data z, processing corresponding to
out_L₁=ReLU(conv1×1(ReLU(z)))
ReLU( ): a normalization linear function (ReLU: Rectified linear unit)
conv1×1( ): a function that returns an output of 1×1 convolution processing,
thereby obtaining output data out_L₁ of the first layer, and
wherein a K+1-th layer (K is a natural number) of the subband learned model receives output data out_Lₖ transmitted from a K-th layer, the K+1-th layer comprising:
a data conversion unit configured to convert output data out_Lₖ transmitted from the K-th layer into two pairs of data x′1_{L} and x′1_{R} each composed of 2^{L-K-1} samples (L is a natural number);
a 1×1 convolution processing unit configured to perform 1×1 convolution processing on the data x′1_{L} and x′1_{R} to obtain data after processing as data x′_{L} and x′_{R};
a weighted-adding unit configured to perform, on the data x′_{L} and x′_{R}, processing corresponding to
z′=W′_{L}×x′_{L}+W′_{R}×x′_{R}
W′_{L}: weighting matrix
W′_{R}: weighting matrix,
thereby obtaining data z′; and
a K+1-th layer activation processing unit configured to perform, on the data z′, processing corresponding to
out_L_{K+1}=ReLU(conv1×1(ReLU(z′)))
ReLU( ): a normalization linear function (ReLU: Rectified linear unit)
conv1×1( ): a function that returns an output of 1×1 convolution processing,
thereby obtaining output data out_L_{K+1} of the K+1-th layer.

11. The audio data inference method according to claim 10, wherein
a first layer of the subband learned model generates data including the data z transmitted from the weighted-adding unit and the data out_L₁ transmitted from the activation processing unit, and outputs the generated data as output data of the first layer.

12. The audio data inference method according to claim 10, wherein
a K+1-th layer of the subband learned model generates data including the data z′ transmitted from the weighted-adding unit and the data out_L_{K+1} transmitted from the K+1-th layer activation processing unit, and outputs the generated data as output data of the K+1-th layer.

13. The audio data inference method according to claim 8, wherein when data obtained by performing filter processing on audio data using a time-invariant noise shaping method is used as data for learning in learning processing, output data is obtained, in inference processing, by performing processing using a filter having filter characteristics opposed to those of the filter processing.

14. The audio data inference method according to claim 8, wherein
the subband synthesis step obtains the output data by performing the synthesis processing after performing band limiting processing on the N subband signals after up-sampling processing using a band limiting filter whose transfer function is as follows:
(1) If −π/(N−1)<ω≤π/(N−1) is satisfied, then
$$H ( ω ) = \sqrt{cos ( \frac{N - 1}{2} ω )}$$
(2) If ω<−π/(N−1) or ω>π/(N−1) is satisfied, then
H(ω)=0.

15. A non-transitory computer readable storage media storing a program enabling a computer to implement the audio data learning method according to claim 1.

16. A non-transitory computer readable storage media storing a program enabling a computer to implement the audio data inference method according to claim 8.
